(19) United States
(12) Patent Application Publication
(10) Pub. No.: US 2026/0045218 A1
(43) Pub. Date: Feb. 12, 2026

(54) ELECTRONIC DEVICE

(71) Applicant: SAMSUNG DISPLAY CO., LTD., YONGIN-SI (KR)

(72) Inventor: CHANG HO HYUN, Yongin-si (KR)

(21) Appl. No.: 19/276,436

(22) Filed: Jul. 22, 2025

(30) Foreign Application Priority Data
Aug. 6, 2024 (KR) 10-2024-0104372

(51) Int. Cl. G09G 3/3233

(52) U.S. Cl. CPC G09G 3/3233; G09G 2300/0452; G09G 2300/0819; G09G 2300/0852; G09G 2300/0861; G09G 2310/08; G09G 2320/0247; G09G 2320/068; G09G 2358/00; G09G 2380/10

(57) ABSTRACT

An electronic device includes a display panel including a pixel. The pixel includes a first light emitting element, a second light emitting element, and a pixel circuit unit. The pixel circuit unit includes a first switching circuit electrically connected to the first light emitting element and applying a driving current to the first light emitting element in response to a first switching signal activated in a first mode, and a second switching circuit electrically connected to the second light emitting element and applying the driving current to the second light emitting element in response to a second switching signal activated in a second mode. The duration of active periods of the first switching signal and the second switching signal gradually increases or decreases during a predetermined period based on a mode switching time point.

### CROSS-REFERENCE TO RELATED APPLICATIONS

This application claims priority under 35 U.S.C. § 119 to Korean Patent Application No. 10-2024-0104372, filed on Aug. 6, 2024, the disclosure of which is incorporated by reference herein in its entirety.

### TECHNICAL FIELD

Embodiments of the present disclosure described herein relate to an electronic device, and more particularly, to an electronic device configured to switch between a wide viewing angle mode and a narrow viewing angle mode.

### DISCUSSION OF RELATED ART

Multimedia electronic devices, such as televisions, mobile phones, tablet PCs, navigation systems, and game consoles, typically include a display for presenting images. Such display-equipped electronic devices may also be installed in vehicles.

In addition to conventional input methods such as buttons, keyboards, or mice, these electronic devices may include an input sensing layer that enables touch-based interaction, allowing users to input information or commands easily and intuitively.

### SUMMARY

Embodiments of the present disclosure are directed to improving display quality in an electronic device capable of switching between a wide viewing angle mode and a narrow viewing angle mode.

According to an embodiment, an electronic device includes a display panel including a pixel and a driving circuit that drives the display panel. The pixel includes a first light emitting element, a second light emitting element, and a pixel circuit unit that drives the first light emitting element and the second light emitting element.

The pixel circuit unit includes a first switching circuit electrically connected to the first light emitting element and applying a driving current to the first light emitting element in response to a first switching signal activated in a first mode, and a second switching circuit electrically connected to the second light emitting element and applying the driving current to the second light emitting element in response to a second switching signal activated in a second mode. A duration of an active period of at least one of the first switching signal and the second switching signal gradually increases or decreases during a predetermined period based on a mode switching time point.

According to an embodiment, an electronic device includes a display panel including a pixel and a driving circuit that drives the display panel. The pixel includes a first light emitting element, a second light emitting element, and a pixel circuit unit that drives the first light emitting element and the second light emitting element.

The pixel circuit unit includes a first switching circuit electrically connected to the first light emitting element and applying a driving current to the first light emitting element in response to a first switching signal activated in a first mode, and a second switching circuit electrically connected to the second light emitting element and applying the driving current to the second light emitting element in response to a second switching signal activated in a second mode.

The pixel circuit unit receives an emission control signal, and a predetermined period set based on a mode switching time point includes a black frame in which the emission control signal is deactivated.

### BRIEF DESCRIPTION OF THE DRAWINGS

The above and other objects and features of the present disclosure will become more apparent by describing in detail embodiments thereof with reference to the accompanying drawings.

FIG. 1 is a drawing illustrating an interior of a vehicle, in which an electronic device is placed, according to an embodiment of the present disclosure.

FIG. 2A is a diagram showing a state, in which a second display area of an electronic device operates in a first mode, according to an embodiment of the present disclosure.

FIG. 2B is a diagram showing a state, in which a second display area of an electronic device operates in a second mode, according to an embodiment of the present disclosure.

FIG. 3A is a diagram showing a state, in which a first display area of an electronic device operates in a first mode, according to an embodiment of the present disclosure.

FIG. 3B is a diagram showing a state, in which a first display area of an electronic device operates in a second mode, according to an embodiment of the present disclosure.

FIG. 4A is a cross-sectional view of an electronic device, according to an embodiment of the present disclosure.

FIG. 4B is a cross-sectional view of an electronic device, according to an embodiment of the present disclosure.

FIG. 5A is an enlarged cross-sectional view of a portion of the electronic device shown in FIG. 4A.

FIG. 5B is an enlarged cross-sectional view of a portion of the electronic device shown in FIG. 4B.

FIG. 6 is a block diagram of a display panel, according to an embodiment of the present disclosure.

FIG. 7 is a circuit diagram of a first pixel, according to an embodiment of the present disclosure.

FIG. 8 is a waveform diagram for describing an operation of the first pixel shown in FIG. 7.

FIG. 9A is a diagram showing a state, in which wide light emitting elements are turned on in a first mode, according to an embodiment of the present disclosure.

FIG. 9B is a diagram showing a state, in which narrow light emitting elements are turned on in the second mode, according to an embodiment of the present disclosure.

FIG. 10A is a cross-sectional view taken along a line I-I′ shown in FIG. 9A.

FIG. 10B is a cross-sectional view taken along a line II-II′ shown in FIG. 9B.

FIGS. 11A and 11B are waveform diagrams showing states of first and second switching signals in a transition period, according to an embodiment of the present disclosure.

FIGS. 12A and 12B are waveform diagrams showing states of first and second switching signals and an emission control signal in a transition period, according to embodiments of the present disclosure.

FIG. 13 is a waveform diagram showing states of first and second switching signals and an emission control signal in first and second black frame insertion periods, according to an embodiment of the present disclosure.

FIG. 14 is a block diagram of the electronic device according to an embodiment of the present disclosure.

FIG. 15 illustrates schematic views of electronic devices according to various embodiments.

### DETAILED DESCRIPTION

Embodiments of the present disclosure will be described more fully hereinafter with reference to the accompanying drawings. Like reference numerals may refer to like elements throughout the accompanying drawings.

The term “and/or” includes one or more combinations in each of which associated elements are defined.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, the terms “under”, “below”, “on”, “above”, etc. are used to describe the correlation of components illustrated in drawings. The terms that are relative in concept are described based on a direction shown in drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

Embodiments of the present disclosure relate to an electronic display device, and more particularly, to a switchable display capable of dynamically transitioning between a wide viewing angle mode and a narrow viewing angle (privacy) mode. This functionality may be useful in automotive environments where the display may need to present information selectively to either the driver or passenger, depending on operational context. Embodiments of the present disclosure address a common challenge in such displays—the occurrence of flickering or visual artifacts during mode transitions—which can degrade user experience and hinder readability.

To solve this problem, embodiments of the present application provide a pixel architecture that includes two light-emitting elements per pixel: one optimized for public mode (wide viewing angle) and another for privacy mode (narrow viewing angle). Each light-emitting element is independently driven by a dedicated switching circuit controlled by a corresponding switching signal. Embodiments may utilize a transition control mechanism in which the duration of the active period of at least one switching signal is gradually increased or decreased around the mode switching time point. This technique may effectively implement a fade-in/fade-out operation, allowing for smooth and flicker-free transitions between modes.

By coordinating pixel-level signal timing with light output characteristics, embodiments of the present application may provide enhanced display performance without the need for complex external components or processing overhead. The result may be a highly adaptable display that can preserve user privacy, improve readability, and enhance visual comfort—all while maintaining seamless visual transitions between operational states.

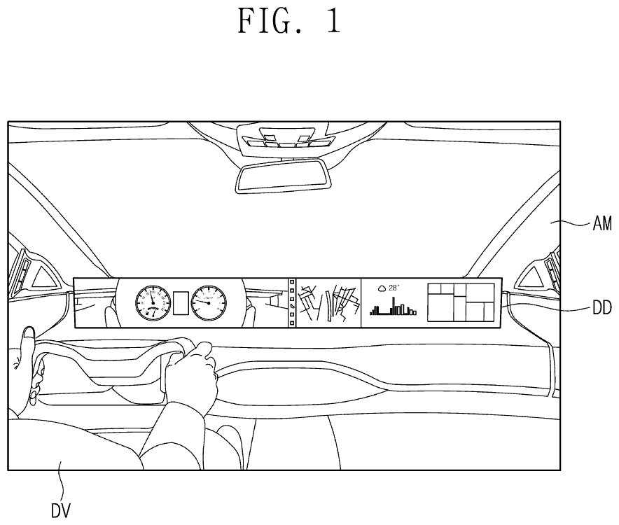

FIG. 1 is a drawing illustrating an interior of a vehicle, in which an electronic device is placed, according to an embodiment of the present disclosure.

Referring to FIG. 1, an electronic device DD may be placed inside a vehicle AM. The electronic device DD may be placed inside the vehicle AM to provide various pieces of information to a driver DV (or user). The electronic device DD may provide the driver DV with information about, for example, weather, speed, maps, or images such as movies. The electronic device DD may be a touch-based electronic device capable of operating in response to a touch input of the driver DV.

Although the electronic device DD for the vehicle AM is illustrated in FIG. 1, an embodiment of the present disclosure is not limited thereto. For example, the electronic device DD according to an embodiment of the present disclosure may be used in electronic devices such as smartphones, digital cameras, notebook computers, monitors, and smart televisions that provide images to users.

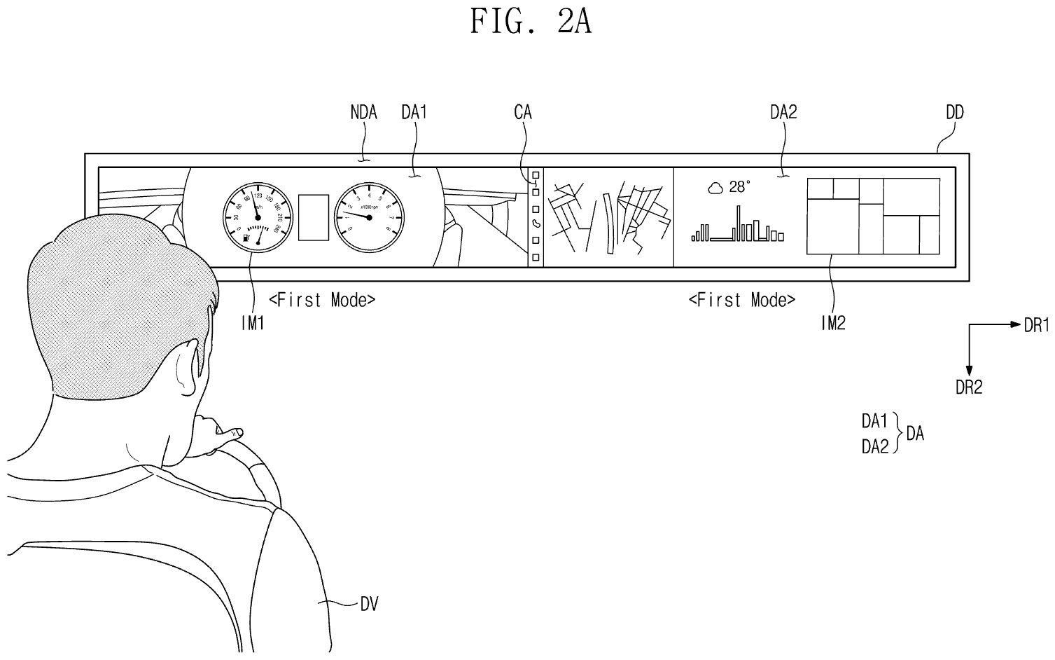

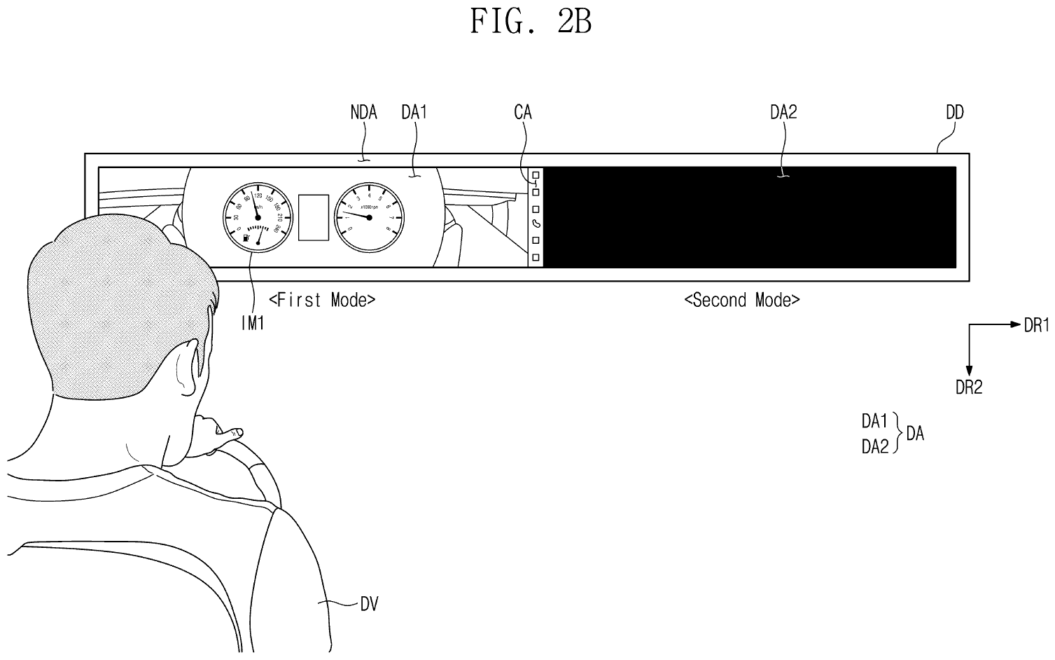

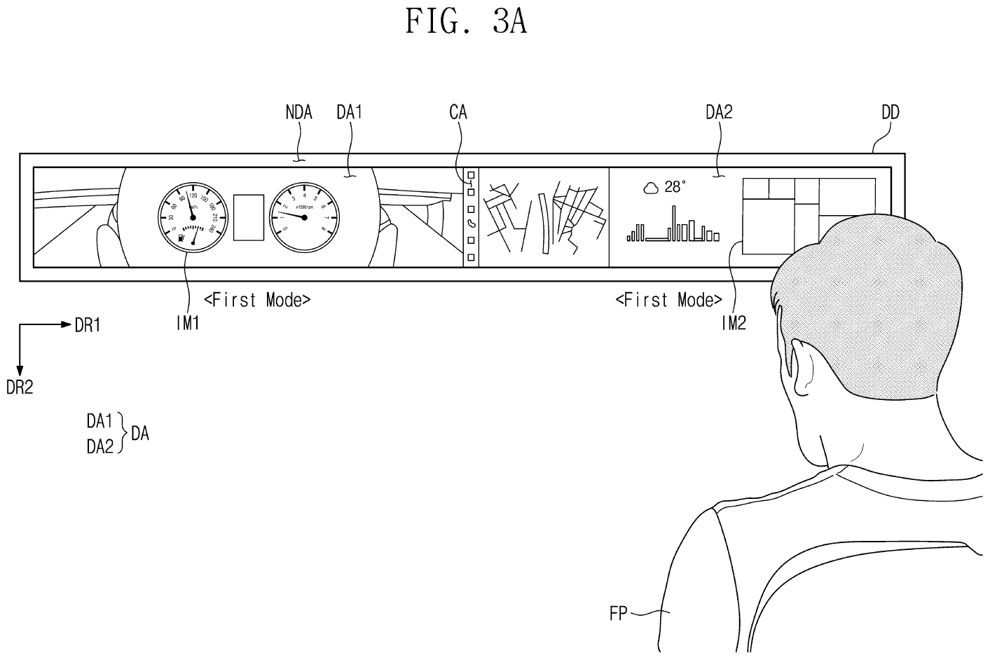

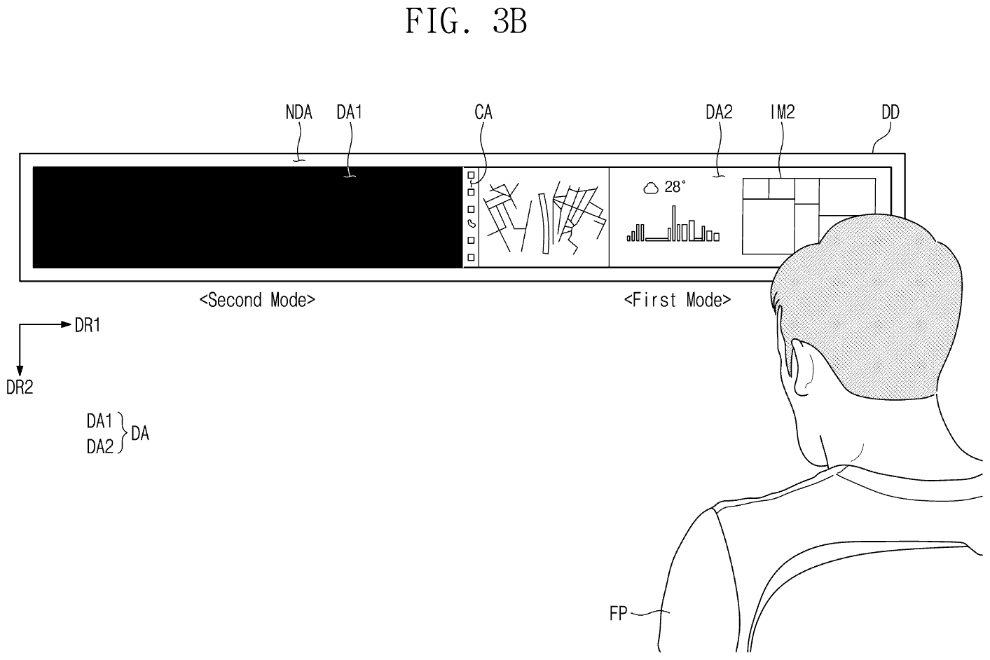

FIG. 2A is a diagram showing a state, in which a second display area of an electronic device operates in a first mode, according to an embodiment of the present disclosure. FIG. 2B is a diagram showing a state, in which a second display area of an electronic device operates in a second mode, according to an embodiment of the present disclosure. FIG. 3A is a diagram showing a state, in which a first display area of an electronic device operates in a first mode, according to an embodiment of the present disclosure. FIG. 3B is a diagram showing a state, in which a first display area of an electronic device operates in a second mode, according to an embodiment of the present disclosure.

Referring to FIGS. 2A and 2B, the electronic device DD may have a plane defined by a first direction DR1 and a second direction DR2 that intersect each other. The electronic device DD may have long sides extending in the first direction DR1 and short sides extending in the second direction DR2. The electronic device DD may have a rectangular shape, but the shape of the electronic device DD is not limited thereto and may have various shapes. Moreover, corner parts of the electronic device DD connecting the long sides and the short sides may have curved shapes.

The front surface of the electronic device DD may be defined as a display surface and may have a plane defined by the first direction DR1 and the second direction DR2. Images generated by the electronic device DD may be provided to a user through a display surface.

The electronic device DD may include a display area DA and a non-display area NDA surrounding the display area DA. The display area DA may display an image, and the non-display area NDA may not display an image. The non-display area NDA may surround the display area DA and may define a border of the electronic device DD printed in predetermined color.

According to an embodiment of the present disclosure, the display area DA may include a first display area DA1 and a second display area DA2. The first display area DA1 and the second display area DA2 are adjacent to each other in the first direction DR1, and an intermediate area CA may be disposed between the first display area DA1 and the second display area DA2. The first display area DA1 displays a first image IM1, and the second display area DA2 displays a second image IM2. The first display area DA1 may be an area located in front of a driver's seat of the vehicle AM (see FIG. 1). The second display area DA2 may be an area located in front of a passenger's seat of the vehicle AM.

According to an embodiment of the present disclosure, the first display area DA1 and the second display area DA2 may be driven independently of each other. For example, the first display area DA1 may display images in a first mode or a second mode, and the second display area DA2 may also display images in the first mode or the second mode. Here, the first mode may be referred to as a “public mode” or a “wide viewing angle mode”. The second mode may be referred to as a “private mode” or a “narrow viewing angle mode”. When one of the first and second display areas DA1 and DA2 operates in the second mode, the image viewing range becomes narrow, and thus an image may be perceived only in the front direction. On the other hand, when one of the first and second display areas DA1 and DA2 operates in the first mode, the image viewing range may be widened, and thus the image may also be perceived in the lateral direction.

As shown in FIGS. 2A and 3A, both the first and second display areas DA1 and DA2 may operate in the first mode. In the first mode, the driver DV of the vehicle AM may perceive not only the first image IM1 displayed in the first display area DA1, but also the second image IM2 displayed in the second display area DA2. Furthermore, in the first mode, a front passenger FP may perceive the first image IM1 displayed in the first display area DA1 as well as the second image IM2 displayed in the second display area DA2.

However, as shown in FIG. 2B, the first display area DA1 may operate in the first mode, and the second display area DA2 may operate in the second mode. In this case, the driver DV may perceive the first image IM1 displayed in the first display area DA1, but may not perceive the second image IM2 displayed in the second display area DA2.

On the other hand, as shown in FIG. 3B, the first display area DA1 may operate in the second mode, and the second display area DA2 may operate in the first mode. In this case, the front passenger FP may perceive the second image IM2 displayed in the second display area DA2, but may not perceive the first image IM1 displayed in the first display area DA1.

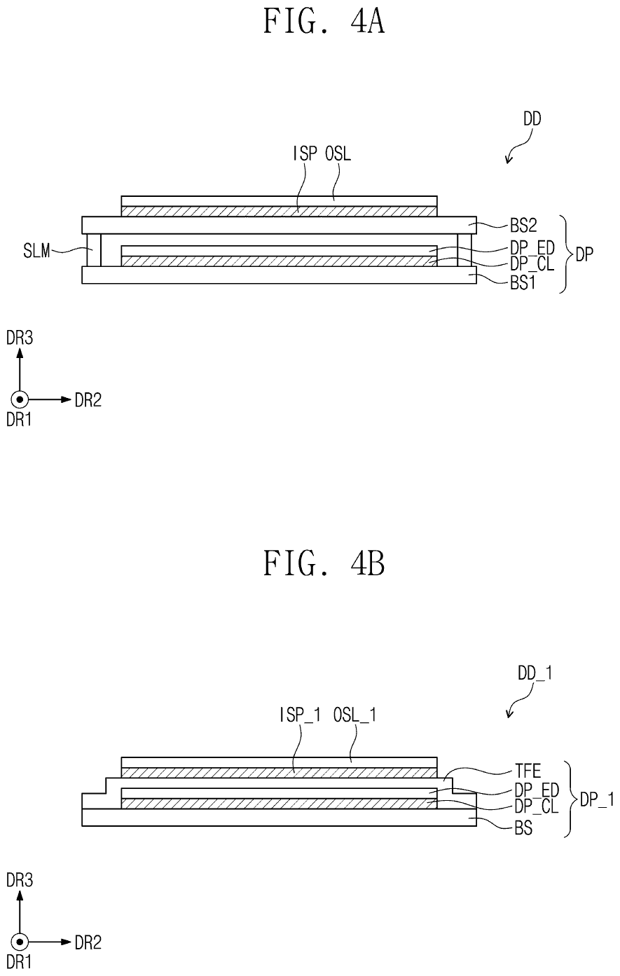

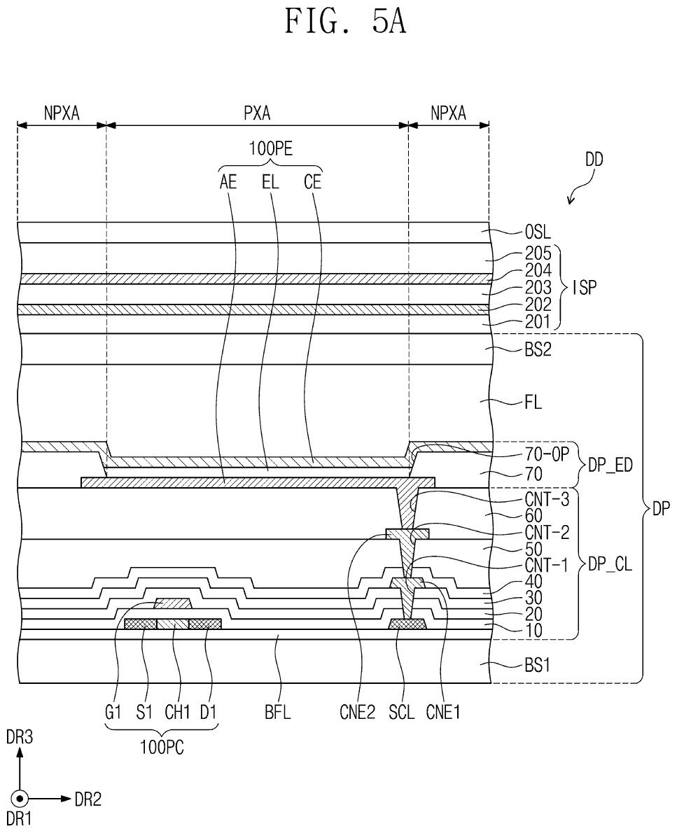

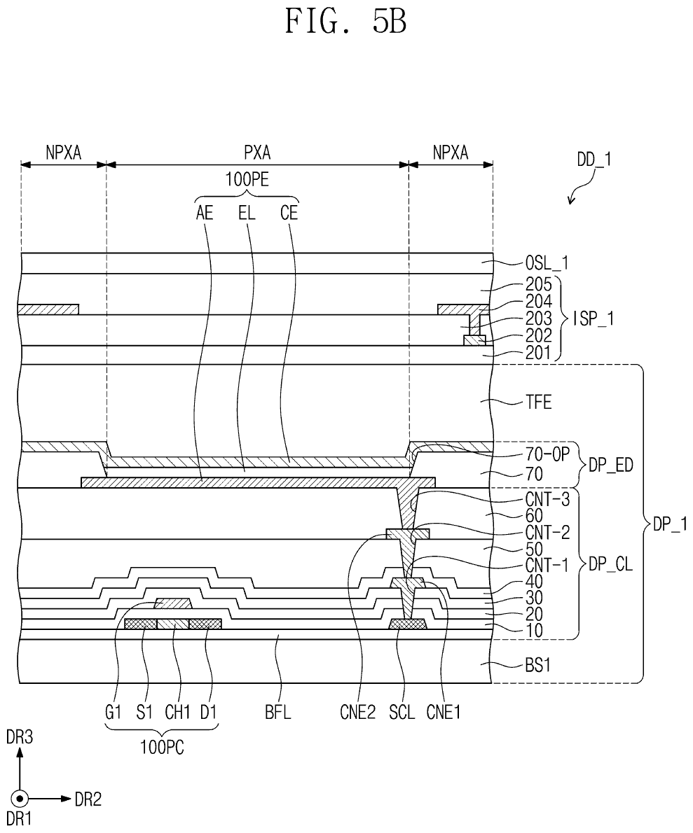

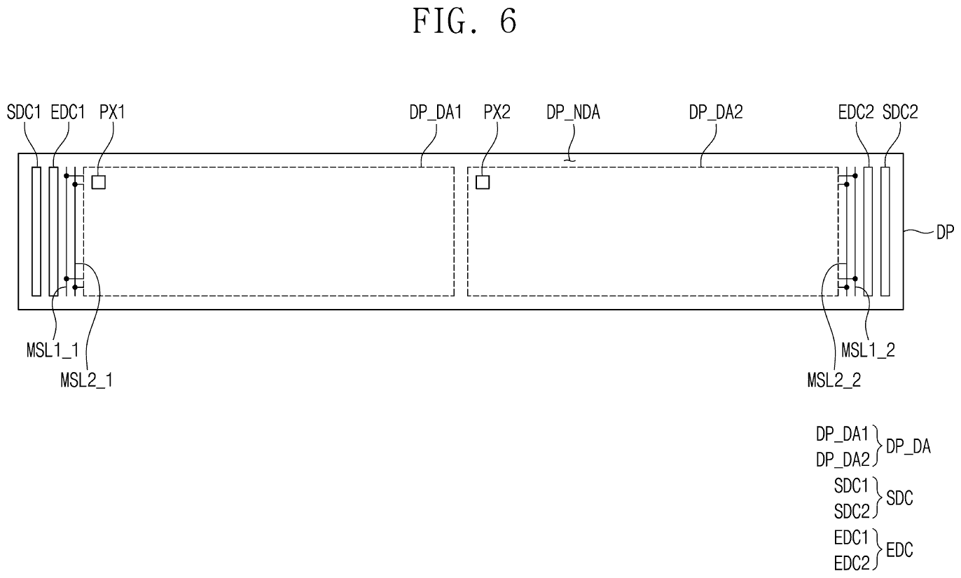

FIG. 4A is a cross-sectional view of an electronic device, according to an embodiment of the present disclosure. FIG. 4B is a cross-sectional view of an electronic device, according to an embodiment of the present disclosure. FIG. 5A is an enlarged cross-sectional view of a portion of the electronic device shown in FIG. 4A. FIG. 5B is an enlarged cross-sectional view of a portion of the electronic device shown in FIG. 4B.

Referring to FIG. 4A, the electronic device DD may include a display panel DP and an input sensing layer ISP. The input sensing layer ISP may be referred to as an “input sensing panel”.

The display panel DP may include a first base layer BS1, a display circuit layer DP_CL, a display element layer DP_ED, a second base layer BS2, and a coupling member SLM. The input sensing layer ISP may be disposed on the second base layer BS2.

Each of the first base layer BS1 and the second base layer BS2 may be a stacked structure including a silicon substrate, a plastic substrate, a glass substrate, an insulating film, or a plurality of insulating layers.

The display circuit layer DP_CL may be disposed on the first base layer BS1. The display circuit layer DP_CL may include a plurality of insulating layers, a plurality of conductive layers, and a semiconductor layer. The plurality of conductive layers of the display circuit layer DP_CL may constitute signal wires or a control circuit of a pixel.

The display element layer DP_ED may be disposed on the display circuit layer DP_CL. The display element layer DP_ED may include light emitting elements. For example, the display element layer DP_ED may include organic light emitting diodes, inorganic light emitting diodes, quantum dots, quantum rods, micro LEDs, or nano LEDs.

The second base layer BS2 may be disposed on the display element layer DP_ED. A predetermined space may be defined between the second base layer BS2 and the display element layer DP_ED. The space may be filled with air or inert gas. Furthermore, in an embodiment of the present disclosure, the space may be filled with a filling layer FL (see FIG. 5A) such as silicone-based polymer, epoxy-based resin, or acrylic-based resin.

The coupling member SLM may be interposed between the first base layer BS1 and the second base layer BS2. The coupling member SLM may combine the first base layer BS1 and the second base layer BS2. The coupling member SLM may include an organic material such as a photocurable resin or a photoplastic resin, or may include an inorganic material such as a frit seal, and is not limited to an embodiment.

The input sensing layer ISP may include a plurality of insulating layers and a plurality of conductive layers. The plurality of conductive layers may include sensing electrodes that sense an external input, sensing wires electrically connected to the sensing electrodes, and sensing pads electrically connected to the sensing wires.

The electronic device DD may further include an optical path control layer OSL. The optical path control layer OSL may be disposed on the input sensing layer ISP. The optical path control layer OSL may include a structure for controlling the path of light output from the display panel DP.

Referring to FIG. 4B, an electronic device DD_1 may include a display panel DP_1, an input sensing layer ISP_1, and an optical path control layer OSL_1.

The display panel DP_1 may include a base layer BS, the display circuit layer DP_CL, the display element layer DP_ED, and an encapsulation layer TFE. The base layer BS may be of a flexible type. The input sensing layer ISP_1 may be disposed on the encapsulation layer TFE. According to an embodiment of the present disclosure, the display panel DP_1 and the input sensing layer ISP_1 may be formed through a sequential process. That is, the input sensing layer ISP_1 may be formed directly on the encapsulation layer TFE.

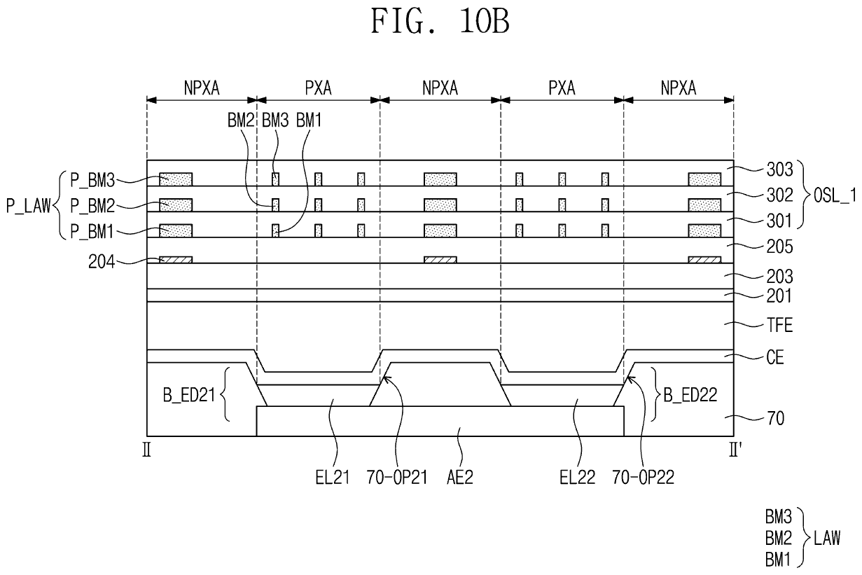

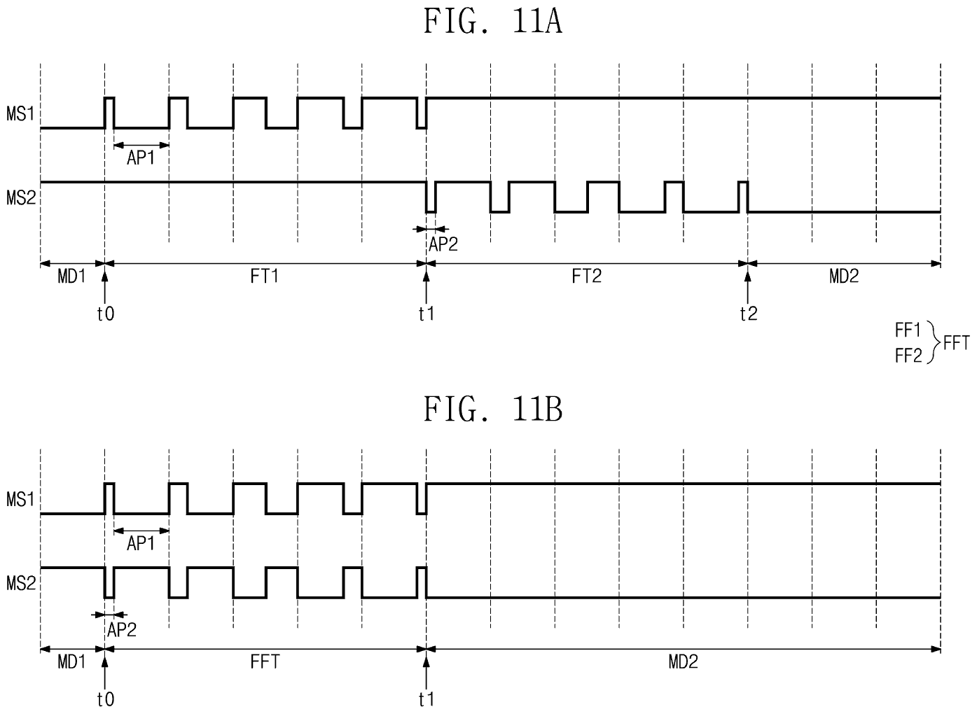

The optical path control layer OSL_1 may be disposed on the input sensing layer ISP_1. The optical path control layer OSL_1 may be formed through a sequential process with the display panel DP_1 and the input sensing layer ISP_1, and may be disposed directly on the input sensing layer ISP_1. However, an embodiment is not particularly limited thereto. For example, the optical path control layer OSL_1 may be coupled to the input sensing layer ISP_1 through an adhesive layer. Configurations of the optical path control layer OSL_1 will be described in further detail below with reference to FIGS. 10A and 10B.

Referring to FIGS. 4A and 5A, at least one inorganic layer may be formed on the upper surface of the first base layer BS1 in the display panel DP. The inorganic layer may include at least one of, for example, aluminum oxide, titanium oxide, silicon oxide, silicon oxynitride, silicon nitride, zirconium oxide, and hafnium oxide. The inorganic layer may be formed of multiple layers. The inorganic layers composed of multiple layers may constitute a barrier layer and/or a buffer layer. In an embodiment, it is illustrated that the display panel DP includes a buffer layer BFL.

The buffer layer BFL may improve a bonding force between the first base layer BS1 and a semiconductor pattern. The buffer layer BFL may include a silicon oxide layer and a silicon nitride layer. The silicon oxide layer and the silicon nitride layer may be stacked alternately.

The semiconductor pattern may be disposed on the buffer layer BFL. The semiconductor pattern may include polysilicon. However, an embodiment is not limited thereto, and the semiconductor pattern may include, for example, amorphous silicon, low-temperature polycrystalline silicon, or an oxide semiconductor.

FIG. 5A only illustrates a part of the semiconductor pattern, and the semiconductor pattern may be further disposed in another area. The semiconductor patterns may be arranged across pixels in a specific rule. The semiconductor pattern may have electrical characteristics different depending on whether the semiconductor pattern is doped. The semiconductor pattern may include a first area having high conductivity and a second area having low conductivity. The first area may be doped with an N-type dopant or a P-type dopant. The P-type transistor may include the doped area doped with a P-type dopant, and the N-type transistor may include the doped area doped with an N-type dopant. The second area may be an undoped area or may be doped with a lower concentration than the first area.

The conductivity of the first area is greater than that of the second area. The first area may substantially operate as an electrode or signal line. The second area may correspond to a channel area of a transistor substantially. In other words, a part of the semiconductor pattern may be a channel part of the transistor, another part thereof may be a source or drain of the transistor, and another part may be a connection electrode or a connection signal line.

Each of the pixels may have an equivalent circuit including a plurality of transistors, at least one capacitor, and a light emitting element. The equivalent circuit of a pixel may be modified in various shapes. One transistor 100PC and one light emitting element 100PE included in a pixel are illustrated in FIG. 5A by way of example.

An embodiment of the present disclosure provides an electronic device that includes a display panel and a driving circuit configured to drive the display panel. The display panel includes pixels, each having a first light-emitting element and a second light-emitting element. A pixel circuit unit is provided to control these elements, and it includes two switching circuits: one connected to the first light-emitting element and another to the second. The first switching circuit supplies a driving current to the first light-emitting element in response to a first switching signal that is activated during a first display mode. The second switching circuit supplies the driving current to the second light-emitting element in response to a second switching signal that is activated during a second display mode. The duration of the active period of at least one of the switching signals is gradually increased or decreased over a set transition period, based on the time at which the display mode changes, in order to enable a smooth transition between modes and reduce visible flicker.

In an embodiment, during a first transition period that occurs before the mode switching time point, the active duration of the first switching signal gradually decreases. Then, in a second transition period that begins after the mode switching time point, the active duration of the second switching signal gradually increases. This coordinated timing allows for a smooth handoff between the two display modes, allowing the display to shift from one light-emitting element to the other without abrupt changes that could lead to visible flicker.

The transistor 100PC may include a source S1, a channel part CH1, a drain D1, and a gate G1. The source S1, the channel part CH1, and the drain D1 may be formed from the semiconductor pattern. The source S1 and the drain D1 may extend in directions opposite to each other from the channel part CH1 on a cross section. A portion of a connection signal line SCL formed from the semiconductor pattern is illustrated in FIG. 5A. The connection signal line SCL may be electrically connected to the drain D1 of the transistor 100PC on a plane.

A first insulating layer 10 may be disposed on the buffer layer BFL. The first insulating layer 10 may overlap a plurality of pixels in common and may cover the semiconductor pattern. The first insulating layer 10 may be an inorganic layer and/or an organic layer, and may have a single-layer structure or a multi-layer structure. The first insulating layer may include at least one of, for example, aluminum oxide, titanium oxide, silicon oxide, silicon nitride, silicon oxynitride, zirconium oxide, and hafnium oxide. In an embodiment, the first insulating layer 10 may be a single silicon oxide layer. Insulating layers of the display circuit layer DP_CL, which is to be described in further detail below, as well as the first insulating layer 10 may be an inorganic layer and/or an organic layer, and may have a single-layer structure or a multi-layer structure. The inorganic layer may include at least one of the above-described materials, but is not limited thereto.

The gate G1 is disposed on the first insulating layer 10. The gate G1 may be a part of a metal pattern. The gate G1 overlaps the channel part CH1. In a process of doping the semiconductor pattern, the gate G1 may function as a mask.

A second insulating layer 20 is disposed on the first insulating layer 10 and may cover the gate G1. The second insulating layer 20 may overlap pixels in common. The second insulating layer 20 may be an inorganic layer and/or an organic layer, and may have a single-layer structure or a multi-layer structure. The second insulating layer 20 may include at least one of silicon oxide, silicon nitride, and silicon oxynitride. In an embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be disposed on the third insulating layer 30. The first connection electrode CNE1 may be connected to the connection signal line SCL through a contact hole CNT-1 penetrating the first, second, and third insulating layers 10, 20, and 30.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The display element layer DP_ED may be disposed on the display circuit layer DP_CL. The display element layer DP_ED may include the light emitting element 100PE and a pixel defining film 70. For example, the display element layer DP_ED may include an organic luminescent material, an inorganic luminescent material, a quantum dot, a quantum rod, a micro-LED, or a nano-LED. Hereinafter, the description will be given under the condition that the light emitting element 100PE is an organic light emitting element, but an embodiment is not particularly limited thereto.

The light emitting element 100PE may include a first electrode AE, a light emitting layer EL, and a second electrode CE. The first electrode AE may be disposed on the sixth insulating layer 60. The first electrode AE may be connected to the second connection electrode CNE2 through a contact hole CNT-3 penetrating the sixth insulating layer 60. The first electrode AE may be referred to as an “anode”.

The pixel defining film 70 may be disposed on the sixth insulating layer 60 and may cover a portion of the first electrode AE. An opening 70-OP is defined in the pixel defining film 70. The opening 70-OP of the pixel defining film 70 exposes at least part of the first electrode AE.

The display area DA (see FIG. 2A) may include an emission area PXA and a non-emission area NPXA adjacent to the emission area PXA. The non-emission area NPXA may surround the emission area PXA. In an embodiment, the emission area PXA is defined to correspond to a partial area of the first electrode AE, which is exposed by the opening 70-OP.

The light emitting layer EL may be disposed on the first electrode AE. The light emitting layer EL may be disposed in an area corresponding to the opening 70-OP. That is, the light emitting layer EL may be separately formed on each of pixels. When the light emitting layers EL are separately formed in each of pixels, each of the light emitting layers EL may emit light of at least one of a blue color, a red color, and a green color. However, an embodiment is not limited thereto. For example, the light emitting layer EL may be connected and provided to each of the pixels in common. In this case, the light emitting layer EL may provide blue light or white light.

The second electrode CE may be disposed on the light emitting layer EL. The second electrode CE may be disposed in a plurality of pixels in common while having an integral shape. The second electrode CE may be referred to as a cathode.

A hole control layer may be interposed between the first electrode AE and the light emitting layer EL. The hole control layer may be disposed in common in the emission area PXA and the non-emission area NPXA. The hole control layer may include a hole transport layer and may further include a hole injection layer. An electron control layer may be interposed between the light emitting layer EL and the second electrode CE. The electron control layer may include an electron transport layer, and may further include an electron injection layer. The hole control layer and the electron control layer may be formed in common in a plurality of pixels by using an open mask.

The second base layer BS2 may be disposed on the display element layer DP_ED. According to an embodiment of the present disclosure, each of the first and second base layers BS1 and BS2 may have a rigid type.

The filling layer FL may be interposed between the first and second base layers BS1 and BS2. The filling layer FL may be placed in a space sealed by a coupling member SLM (see FIG. 4A) between the first and second base layers BS1 and BS2. The filling layer FL may include a thermosetting material.

The input sensing layer ISP may be directly disposed on the display panel DP. For example, the input sensing layer ISP may be directly disposed on the second base layer BS2.

Referring to FIGS. 4B and 5B, the encapsulation layer TFE may be disposed on the display element layer DP_ED. The encapsulation layer TFE may include an inorganic layer, an organic layer, and an inorganic layer, which are sequentially stacked, but layers constituting the encapsulation layer TFE are not limited thereto.

The inorganic layers may protect the display element layer DP_ED from moisture and oxygen, and the organic layer may protect the display element layer DP_ED from a foreign material such as dust particles. The inorganic layers may include, for example, a silicon nitride layer, a silicon oxynitride layer, a silicon oxide layer, a titanium oxide layer, an aluminum oxide layer, or the like. The organic layer may include an acrylate-based organic layer, but is not limited thereto.

The input sensing layer ISP_1 may be formed on the display panel DP_1 through sequential processes. In this case, it may be expressed that the input sensing layer ISP_1 is directly disposed on the display panel DP_1 (e.g., the encapsulation layer TFE). The expression “directly disposed” may mean that another, intervening component is not interposed between the input sensing layer ISP_1 and the display panel DP_1. That is, a separate adhesive member or a separate coupling member may not be interposed between the input sensing layer ISP_1 and the display panel DP_1. Alternatively, the input sensing layer ISP_1 may be coupled to the display panel DP_1 through the adhesive member or the coupling member. The adhesive member may include a typical adhesive or a typical sticking agent.

Referring to FIGS. 5A and 5B, each of the input sensing layers ISP and ISP_1 may include a base insulating layer 201, a first conductive layer 202, an intermediate insulating layer 203, a second conductive layer 204, and a cover insulating layer 205.

The base insulating layer 201 may be an inorganic layer including at least one of silicon nitride, silicon oxynitride, and silicon oxide. Alternatively, the base insulating layer 201 may be an organic layer including, for example, an epoxy resin, an acrylate resin, or an imide-based resin. The base insulating layer 201 may have a single-layer structure or may have a multi-layer structure stacked in a third direction DR3.

Each of the first conductive layer 202 and the second conductive layer 204 may have a single-layer structure or may have a multi-layer structure in which layers are stacked in the third direction DR3.

A conductive layer of a single-layer structure may include a metal layer or a transparent conductive layer. The metal layer may include molybdenum, silver, titanium, copper, aluminum, or an alloy thereof. The transparent conductive layer may include transparent conductive oxide such as indium tin oxide, indium zinc oxide, zinc oxide, or indium zinc tin oxide. Besides, the transparent conductive layer may include a conductive polymer such as PEDOT, a metal nano wire, graphene, and the like.

A conductive layer of the multi-layer structure may include metal layers. For example, the metal layers may have a three-layer structure of titanium/aluminum/titanium. The conductive layer of the multi-layer structure may include at least one metal layer and at least one transparent conductive layer.

At least one of the intermediate insulating layer 203 and the cover insulating layer 205 may include an inorganic film. The inorganic film may include at least one of aluminum oxide, titanium oxide, silicon oxide, silicon nitride, silicon oxynitride, zirconium oxide, and hafnium oxide.

At least one of the intermediate insulating layer 203 and the cover insulating layer 205 may include an organic film. The organic film may include at least one of acrylate-based resin, methacrylate-based resin, polyisoprene, vinyl-based resin, epoxy-based resin, urethane-based resin, cellulose-based resin, siloxane-based resin, polyimide-based resin, polyamide-based resin, and perylene-based resin.

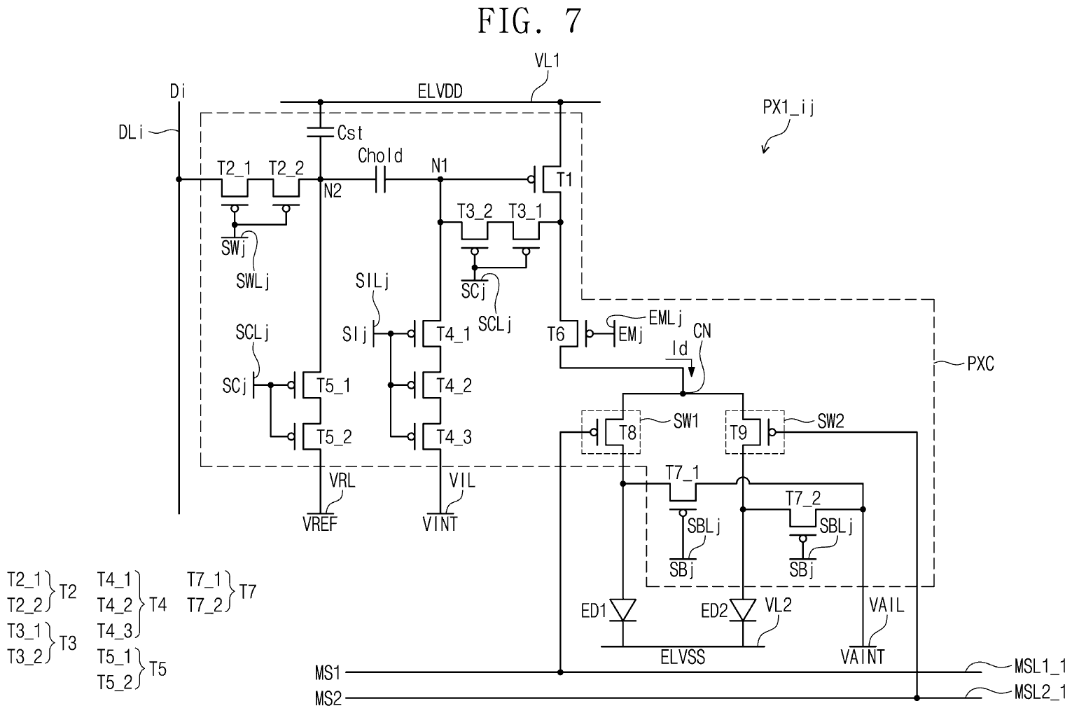

FIG. 6 is a block diagram of a display panel, according to an embodiment of the present disclosure.

Referring to FIG. 6, the display panel DP may generate and display an image. The display panel DP may be a light emitting display panel. For example, the display panel DP may be an organic light emitting display panel, a quantum dot display panel, a micro-LED display panel, or a nano-LED display panel.

The display panel DP includes a display area DP_DA and a non-display area DP_NDA adjacent to the display area DP_DA. The display area DP_DA may be an area corresponding to the display area DA illustrated in FIG. 2A. The non-display area DP_NDA may be an area corresponding to the non-display area NDA illustrated in FIG. 2A. The display area DP_DA is an area in which an image is actually displayed, and the non-display area DP_NDA is a bezel area in which an image is not displayed.

The display area DP_DA includes a first display area DP_DA1 and a second display area DP_DA2. The first display area DP_DA1 is an area corresponding to the first display area DA1 illustrated in FIG. 2A. The second display area DP_DA2 is an area corresponding to the second display area DA2 illustrated in FIG. 2A. FIG. 6 illustrates a structure in which the non-display area DP_NDA is disposed to surround the first and second display areas DP_DA1 and DP_DA2, but the present disclosure is not limited thereto. The non-display area DP_NDA may be disposed on only at least one side of the first and second display areas DP_DA1 and DP_DA2.

The display panel DP includes a plurality of pixels and signal lines connected to the plurality of pixels. Each of the pixels may include a light emitting element. The signal lines may include data lines, scan lines, emission control lines, and power source lines. Here, pixels placed in the first display area DP_DA1 are referred to as “first pixels PX1”, and pixels placed in the second display area DP_DA2 are referred to as “second pixels PX2”. According to an embodiment of the present disclosure, the first pixels PX1 and the second pixels PX2 may have the same shape and the same size as each other.

The electronic device DD (see FIG. 2A) further includes a driving circuit for driving the display panel DP. The driving circuit may include a scan driving circuit SDC and an emission driving circuit EDC. The scan driving circuit SDC includes a first scan driving circuit SDC1 connected to the first display area DP_DA1 and the second scan driving circuit SDC2 connected to the second display area DP_DA2. The emission driving circuit EDC includes a first emission driving circuit EDC1 connected to the first display area DP_DA1 and a second emission driving circuit EDC2 connected to the second display area DP_DA2.

According to an embodiment of the present disclosure, the first scan driving circuit SDC1 and the first emission driving circuit EDC1 are disposed on one side (e.g., left) of the first display area DP_DA1, and the second scan driving circuit SDC2 and the second emission driving circuit EDC2 are disposed on one side (e.g., right) of the second display area DP_DA2. Alternatively, the first scan driving circuit SDC1 and the first emission driving circuit EDC1 may be respectively disposed on both sides of the first display area DP_DA1, and the second scan driving circuit SDC2 and the second emission driving circuit EDC2 may be respectively disposed on both sides of the second display area DP_DA2.

A 1-1st switching line MSL1_1 and a 2-1st switching line MSL2_1 are disposed on one side (e.g., left) of the first display area DP_DA1. A 1-2nd switching line MSL1_2 and a 2-2nd switching line MSL2_2 are disposed on one side (e.g., right) of the second display area DP_DA2. The 1-1st switching line MSL1_1 and the 2-1st switching line MSL2_1 are connected to the first pixels PX1, and the 1-2nd switching line MSL1_2 and the 2-2nd switching line MSL2_2 are connected to the second pixels PX2.

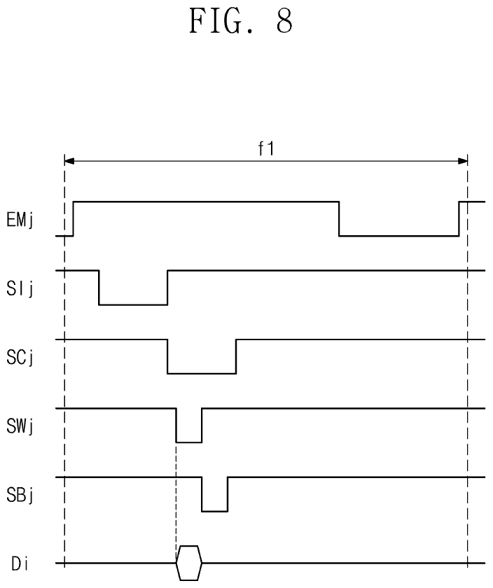

The 1-1st switching line MSL1_1 and the 2-1st switching line MSL2_1 may respectively receive first and second switching signals MS1 and MS2 (see FIG. 7) from a driving controller that controls the driving of the scan driving circuit SDC and the emission driving circuit EDC. The 1-2nd switching line MSL1_2 and the 2-2nd switching line MSL2_2 may receive the first and second switching signals MS1 and MS2 (see FIG. 7) from the driving controller, respectively.

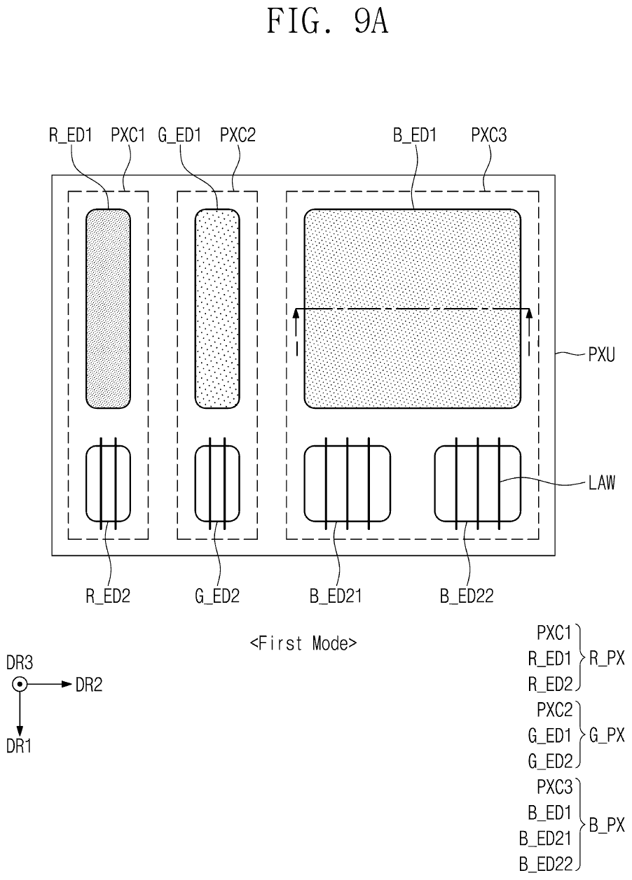

FIG. 7 is a circuit diagram of a first pixel, according to an embodiment of the present disclosure. FIG. 8 is a waveform diagram for describing an operation of the first pixel shown in FIG. 7. FIG. 7 shows an equivalent circuit diagram of one first pixel PX1_ij among a plurality of first pixels PX1 shown in FIG. 6. Because each of the plurality of first pixels has the same circuit structure, a detailed description of the remaining first pixels will be replaced with a description of a circuit structure of the first pixel PX1_ij.

Referring to FIG. 7, the first pixel PX1_ij is connected to an i-th data line DLi (hereinafter referred to as a “data line”) among data lines, connected to a j-th initialization scan line SILj (hereinafter referred to as an “initialization scan line”), a j-th compensation scan line SCLj (hereinafter referred to as a “compensation scan line”), a j-th write scan line SWLj (hereinafter referred to as a “write scan line”), and a j-th black scan line SBLj (hereinafter referred to as a “black scan line”) among scan lines, and connected to a j-th emission control line EMLj (hereinafter referred to as an “emission control line”) among emission control lines. According to an embodiment of the present disclosure, the first pixel PX1_ij is connected to the 1-1st switching line MSL1_1 and the 2-1st switching line MSL2_1.

The first pixel PX1_ij includes a first light emitting element ED1, a second light emitting element ED2, and a pixel circuit unit PXC. The pixel circuit unit PXC includes first to ninth transistors T1, T2, T3, T4, T5, T6, T7, T8, and T9, and first and second capacitors Cst and Chold. Each of the first to ninth transistors T1 to T9 may be a transistor having a low-temperature polycrystalline silicon (LTPS) semiconductor layer. All of the first to ninth transistors T1 to T9 may be P-type transistors. However, the present disclosure is not limited thereto. For example, all of the first to ninth transistors T1 to T9 may be N-type transistors. In an embodiment, some of the first to ninth transistors T1 to T9 may be P-type transistors, and the other(s) thereof may be N-type transistors. For example, among the first to ninth transistors T1 to T9, the first, second, and fifth to ninth transistors T1, T2, and T5 to T9 are P-type transistors, and the third and fourth transistors T3 and T4 may be N-type transistors by using an oxide semiconductor as a semiconductor layer. However, a configuration of the pixel circuit unit PXC according to an embodiment of the present disclosure is not limited to an embodiment illustrated in FIG. 7. The pixel circuit unit PXC illustrated in FIG. 7 is only an example. For example, the configuration of the pixel circuit unit PXC may be variously modified and implemented. For example, all of the first to ninth transistors T1 to T9 may be P-type transistors or N-type transistors.

The initialization scan line SILj may apply a j-th initialization scan signal SIj (hereinafter referred to as an “initialization scan signal”) to the first pixel PX1_ij, the compensation scan line SCLj may apply a j-th compensation scan signal SCj (hereinafter referred to as a “compensation scan signal”) to the first pixel PX1_ij, the write scan line SWLj may apply a j-th write scan signal SWj (hereinafter referred to as a “write scan signal”) to the first pixel PX1_ij, the black scan line SBLj may apply a j-th black scan signal SBj (hereinafter referred to as a “black scan signal”) to the pixel first PX1_ij, and the emission control line EMLj may apply a j-th emission control signal EMj (hereinafter referred to as an “emission control signal”) to the first pixel PX1_ij. The data line DLi applies a data signal Di to the first pixel PX1_ij. The 1-1st switching line MSL1_1 may apply the first switching signal MS1 to the first pixel PX1_ij. The 2-1st switching line MSL2_1 may apply the second switching signal MS2 to the first pixel PX1_ij.

First and second driving voltage lines VL1 and VL2 may supply a first driving voltage ELVDD and a second driving voltage ELVSS to the first pixel PX1_ij, respectively. The first pixel PX1_ij may receive a first initialization voltage VINT and a second initialization voltage VAINT through first and second initialization voltage lines VIL and VAIL, respectively. The first pixel PX1_ij may further receive a reference voltage VREF through a reference voltage line VRL. FIG. 7 illustrates a structure in which five voltage lines are connected to the first pixel PX1_ij, but the number of voltage lines connected to the first pixel PX1_ij may be changed in various ways.

The first transistor T1 includes a first electrode connected to the first driving voltage line VL1, a second electrode electrically connected to a common node CN via the sixth transistor T6, and a gate electrode connected to a first end of the second capacitor Chold (also referred to as a “first node N1”). The first transistor T1 may receive the data signal Di delivered through the data line DLi depending on the switching operation of the second transistor T2 and then may supply a driving current Id to the common node CN.

The second transistor T2 may include a 2-1st transistor T2_1 and a 2-2nd transistor T2_2. The 2-1st transistor T2_1 includes a first electrode connected to the data line DLi, a second electrode connected to a first electrode of the 2-2nd transistor T2_2, and a gate electrode connected to the write scan line SWLj. The 2-2nd transistor T2_2 includes a first electrode connected to the second electrode of the 2-1st transistor T2_1, a second electrode connected to a second end of the second capacitor Chold (or referred to as a “second node N2”), and a gate electrode connected to the write scan line SWLj. The 2-1st and 2-2nd transistors T2_1 and T2_2 may be turned on in response to the write scan signal SWj received through the write scan line SWLj to deliver the data signal Di delivered from the data line DLi to the gate electrode of the first transistor T1.

A first end of the first capacitor Cst is connected to the second node N2, and a second end of the first capacitor Cst is connected to the first driving voltage line VL1.

The third transistor T3 may include a 3-1st transistor T3_1 and a 3-2nd transistor T3_2. The 3-1st transistor T3_1 includes a first electrode connected to the second electrode of the first transistor T1, a second electrode connected to a first electrode of the 3-2nd transistor T3_2, and a gate electrode connected to the compensation scan line SCLj. The 3-2nd transistor T3_2 includes a first electrode connected to the second electrode of the 3-1st transistor T3_1, a second electrode connected to the gate electrode of the first transistor T1 (e.g., the first node N1), and a gate electrode connected to the compensation scan line SCLj. The 3-1st and 3-2nd transistor T3_1 and T3_2 may be turned on in response to the compensation scan signal SCj received through the compensation scan line SCLj, and thus, the gate electrode and the second electrode of the first transistor T1 may be connected, that is, the first transistor T1 may be diode-connected.

The fourth transistor T4 may include a 4-1st transistor T4_1, a 4-2nd transistor T4_2, and a 4-3rd transistor T4_3. The 4-1st transistor T4_1, the 4-2nd transistor T4_2, and the 4-3rd transistor T4_3 may be connected in series between the first node N1 and the first initialization voltage line VIL. The gate electrode of each of the 4-1st transistor T4_1, the 4-2nd transistor T4_2, and the 4-3rd transistor T4_3 is commonly connected to the initialization scan line SILj to receive the initialization scan signal SIj. When the 4-1st transistor T4_1, the 4-2nd transistor T4_2, and the 4-3rd transistor T4_3 are turned on in response to the initialization scan signal SIj, the gate electrode (e.g., the first node N1) of the first transistor T1 may be initialized to the first initialization voltage VINT.

The fifth transistor T5 may include a 5-1st transistor T5_1 and a 5-2nd transistor T5_2. The 5-1st transistor T5_1 and the 5-2nd transistor T5_2 may be connected in series between the second node N2 and the reference voltage line VRL. The gate electrode of each of the 5-1st transistor T5_1 and the 5-2nd transistor T5_2 is commonly connected to the compensation scan line SCLj to receive the compensation scan signal SCj. When the 5-1st transistor T5_1 and the 5-2nd transistor T5_2 are turned on in response to the compensation scan signal SCj, the second node N2 may be initialized to the reference voltage VREF.

The sixth transistor T6 (or referred to as an “emission control transistor”) includes a first electrode connected to the second electrode of the first transistor T1, a second electrode connected to the common node CN, and a gate electrode connected to the emission control line EMLj.

The sixth transistor T6 is turned on in response to the emission control signal EMj received through the emission control line EMLj. The driving current Id may be delivered to the common node CN through the turned-on sixth transistor T6.

The seventh transistor T7 may include a 7-1st transistor T7_1 and a 7-2nd transistor T7_2. The 7-1st transistor T7_1 (or referred to as a “first initialization transistor”) includes a first electrode connected to an anode of the first light emitting element ED1, a second electrode connected to the second initialization voltage line VAIL, and a gate electrode connected to the black scan line SBLj. The 7-2nd transistor T7_2 (or referred to as a “second initialization transistor”) includes a first electrode connected to an anode of the second light emitting element ED2, a second electrode connected to the second initialization voltage line VAIL, and a gate electrode connected to the black scan line SBLj. The gate electrode of each of the 7-1st transistor T7_1 and the 7-2nd transistor T7_2 is commonly connected to the black scan line SBLj to receive the black scan signal SBj. When the 7-1st transistor T7_1 and the 7-2nd transistor T7_2 are turned on in response to the black scan signal SBj, the anodes of the first and second light emitting elements ED1 and ED2 may be initialized to the second initialization voltage VAINT.

The cathode of each of the first and second light emitting elements ED1 and ED2 may be connected to the second driving voltage line VL2 that delivers the second driving voltage ELVSS.

A first switching circuit SW1 is disposed between the common node CN and the first light emitting element ED1, and a second switching circuit SW2 is disposed between the common node CN and the second light emitting element ED2. According to an embodiment of the present disclosure, the first switching circuit SW1 includes the eighth transistor T8, and the second switching circuit SW2 includes the ninth transistor T9. The eighth transistor T8 may be referred to as a “first mode switching transistor”, and the ninth transistor T9 may be referred to as a “second mode switching transistor”. The eighth transistor T8 includes a first electrode connected to the common node CN, a second electrode connected to the anode of the first light emitting element ED1, and a gate electrode connected to the 1-1st switching line MSL1_1. The ninth transistor T9 includes a first electrode connected to the common node CN, a second electrode connected to the anode of the second light emitting element ED2, and a gate electrode connected to the 2-1st switching line MSL2_1.

In the first mode, the eighth transistor T8 may be turned on in response to the first switching signal MS1 transmitted through the 1-1st switching line MSL1_1, and the first light emitting element ED1 may receive the driving current Id through the turned-on eighth transistor T8. In the first mode, the ninth transistor T9 may be turned off, and thus the driving current Id may be provided to only the first light emitting element ED1. In the second mode, the ninth transistor T9 may be turned on in response to the second switching signal MS2 transmitted through the 2-1st switching line MSL2_1, and the second light emitting element ED2 may receive the driving current Id through the turned-on ninth transistor T9. In the second mode, the eighth transistor T8 is turned off, and thus the driving current Id may be provided to only the second light emitting element ED2.

The first pixel PX1_ij may display an image through the first light emitting element ED1 in the first mode, and may display an image through the second light emitting element ED2 in the second mode. However, the present disclosure is not limited thereto. Alternatively, the first pixel PX1_ij may display an image by using the first and second light emitting elements ED1 and ED2 in the first mode, and may display an image by using only the second light emitting element ED2 in the second mode. In this case, in the first mode, the eighth and ninth transistors T8 and T9 may be turned on simultaneously.

Referring to FIGS. 7 and 8, when the initialization scan signal SIj having a low level is provided through the initialization scan line SILj during the initialization period of one frame f1, the 4-1st, 4-2nd, and 4-3rd transistors T4_1, T4_2, and T4_3 are turned on in response to the initialization scan signal SIj having the low level. The first initialization voltage VINT is delivered to the gate electrode of the first transistor T1 (e.g., the first node N1) through the turned-on 4-1st, 4-2nd, and 4-3rd transistors T4_1, T4_2, and T4_3, and the gate electrode of the first transistor T1 is initialized by the first initialization voltage VINT.

Next, when the compensation scan signal SCj of a low level is supplied through the compensation scan line SCLj during the compensation period of the one frame f1, the 3-1st and 3-2nd transistors T3_1 and T3_2 are turned on. A compensation period may not overlap an initialization period. The activation section of the compensation scan signal SCj is defined as a section in which the compensation scan signal SCj has a low level. The activation section of the initialization scan signal SIj is defined as a section in which the initialization scan signal SIj has a low level. The activation section of the compensation scan signal SCj may not overlap the activation section of the initialization scan signal SIj. The activation section of the initialization scan signal SIj may precede the activation section of the compensation scan signal SCj.

During the compensation period, the first transistor T1 is diode-connected by the turned-on 3-1st and 3-2nd transistors T3_1 and T3_2 and is forward-biased. Moreover, the compensation period may include a data write period in which the write scan signal SWj is generated to have a low level. During the data write period, the 2-1st and 2-2nd transistors T2_1 and T2_2 are turned on by the write scan signal SWj having the low level. Then, a compensation voltage “Di-Vth” obtained by reducing the voltage of the data signal Di supplied from the data line DLi by a threshold voltage “Vth” of the first transistor T1 is applied to the gate electrode of the first transistor T1. That is, the potential of the gate electrode of the first transistor T1 may be the compensation voltage “Di-Vth”.

The first driving voltage ELVDD and the data signal Di may be respectively applied to opposite ends of the first capacitor Cst, and charges corresponding to a voltage difference between the opposite ends of the first capacitor Cst may be stored in the first capacitor Cst.

In the meantime, the 7-1st and 7-2nd transistors T7_1 and T7_2 are turned on by receiving the black scan signal SBj of a low-level through the black scan line SBLj. A portion of the driving current Id may be drained through the 7-1st and 7-2nd transistors T7_1 and T7_2 as a bypass current.

Next, the emission control signal EMj supplied from the emission control line EMLj is changed from a high level to a low level. The sixth transistor T6 is turned on by the emission control signal EMj having a low level. Accordingly, the driving current Id according to a voltage difference between the gate voltage of the gate electrode of the first transistor T1 and the first driving voltage ELVDD may be generated and provided to the common node CN through the sixth transistor T6. The driving current Id may be provided to the first light emitting element ED1 or the second light emitting element ED2 through the eighth or ninth transistor T8 or T9 turned on depending on a mode.

The circuit structure of the first pixels PX1 may be identical to the circuit structure of the second pixels PX2 (see FIG. 6). However, the first and second switching circuits SW1 and SW2 of the second pixel PX2 are respectively connected to the 1-2nd switching line MSL1_2 and the 2-2nd switching line MSL2_2 to receive the first and second switching signals MS1 and MS2, respectively.

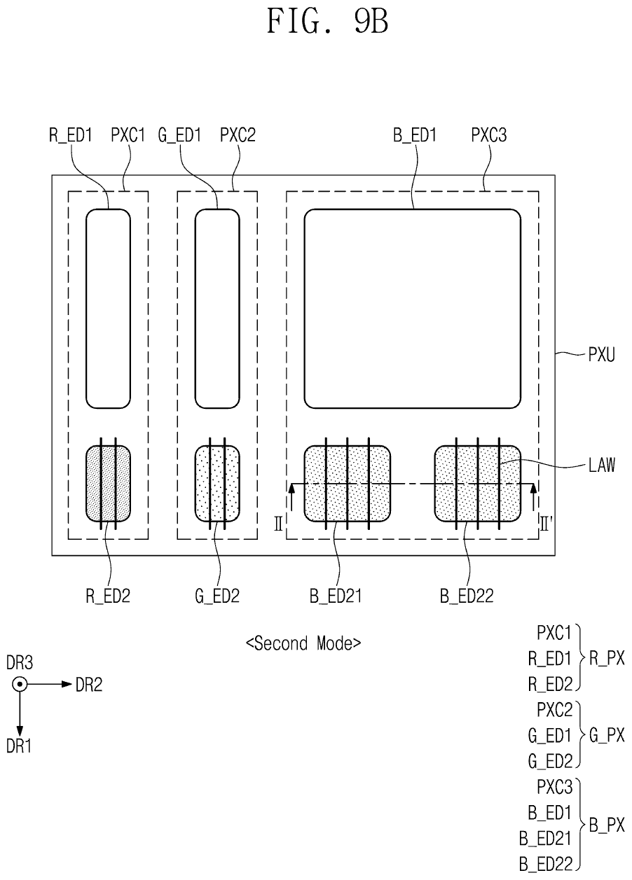

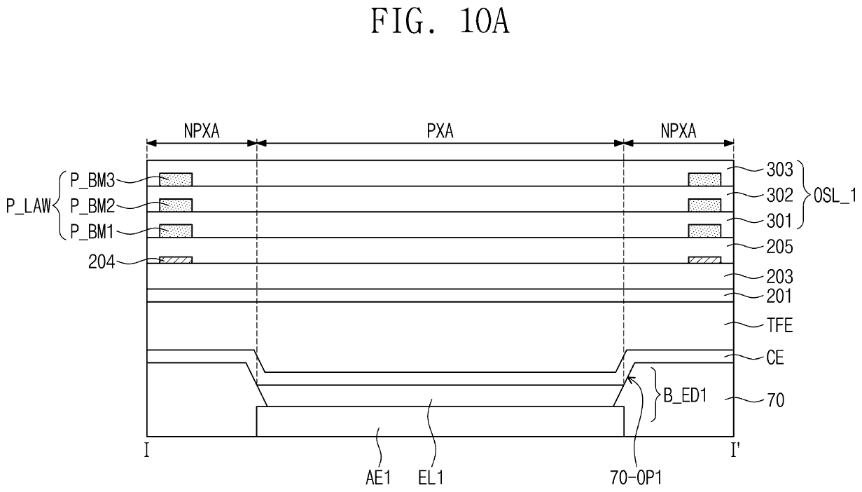

FIG. 9A is a diagram showing a state in which a wide light emitting element is turned on in a first mode, according to an embodiment of the present disclosure. FIG. 9B is a diagram showing a state in which a narrow light emitting element is turned on in a second mode, according to an embodiment of the present disclosure. FIG. 10A is a cross-sectional view taken along a line I-I′ shown in FIG. 9A. FIG. 10B is a cross-sectional view taken along a line II-II′ shown in FIG. 9B.

Referring to FIGS. 9A and 9B, the plurality of first pixels PX1 (see FIG. 6) may be placed in units of pixel cell PXU in the first display area DP_DA1 (see FIG. 6), and the plurality of second pixels PX2 (see FIG. 6) may be placed in units of pixel cell PXU in the second display area DP_DA2 (see FIG. 6).

According to an embodiment of the present disclosure, the pixel cell PXU may include a red pixel R_PX, a green pixel G_PX, and a blue pixel B_PX. The red pixel R_PX includes a red pixel circuit PXC1, a first red light emitting element R_ED1, and a second red light emitting element R_ED2. The green pixel G_PX includes a green pixel circuit PXC2, a first green light emitting element G_ED1, and a second green light emitting element G_ED2. The blue pixel B_PX includes a blue pixel circuit PXC3, a first blue light emitting element B_ED1, a 2-1st blue light emitting element B_ED21, and a 2-2nd blue light emitting element B_ED22. Here, the first red light emitting element R_ED1, the first green light emitting element G_ED1, and the first blue light emitting element B_ED1 may be referred to as “wide light emitting elements”. The second red light emitting element R_ED2, the second green light emitting element G_ED2, and the 2-1st and 2-2nd blue light emitting elements B_ED21 and B_ED22 may be referred to as “narrow light emitting elements”.

According to an embodiment of the present disclosure, the first red light emitting element R_ED1 may have a size larger than the second red light emitting element R_ED2. The first green light emitting element G_ED1 may have a size larger than the second green light emitting element G_ED2. The first blue light emitting element B_ED1 may have a size larger than the 2-1st blue light emitting element B_ED21 and the 2-2nd blue light emitting element B_ED22. The 2-1st blue light emitting element B_ED21 and the 2-2nd blue light emitting element B_ED22 may have the same size as each other.

Although FIGS. 9A and 9B illustrate that the wide light emitting element has a size larger than the narrow light emitting element, the present disclosure is not limited thereto. For example, the first red light emitting element R_ED1 may have the same size as the second red light emitting element R_ED2. The first green light emitting element G_ED1 may have the same size as the second green light emitting element G_ED2.

A plurality of light absorption walls LAW may be formed on the narrow light emitting element. The plurality of light absorption walls LAW may overlap the narrow light emitting element and may not overlap the wide light emitting element. The plurality of light absorption walls LAW may be a configuration included in the optical path control layers OSL and OSL_1 illustrated in FIGS. 4A to 5B. According to an embodiment of the present disclosure, the plurality of light absorption walls LAW may overlap emission areas respectively corresponding to the second red light emitting element R_ED2, the second green light emitting element G_ED2, the 2-1st and 2-2nd blue light emitting elements B_ED21 and B_ED22. According to an embodiment of the present disclosure, each of the plurality of light absorption walls LAW may extend in the first direction DR1. The plurality of light absorption walls LAW may be spaced from each other in the second direction DR2. The light absorption walls LAW may absorb some of light (e.g., referred to as “lateral light”), which propagates in a lateral direction, from among light output from the second red light emitting element R_ED2, the second green light emitting element G_ED2, the 2-1st and 2-2nd blue light emitting elements B_ED21 and B_ED22. The lateral light may refer to light emitted in a direction, which is inclined at a specific angle or more with respect to a normal line perpendicular to a light emitting surface of the narrow light emitting element.

In the first mode, the pixel cell PXU may display an image by using the wide light emitting element. In the second mode, the pixel cell PXU may display an image by using a narrow light emitting element. In the second mode, the lateral light of the light output through the narrow light emitting element may be absorbed through the light absorption wall LAW, and thus the viewing angle of an image displayed in the second mode may be narrower than the viewing angle of an image displayed in the first mode. Accordingly, when the first display area DP_DA1 operates in the second mode, the front passenger FP (see FIG. 3A) may not perceive the first image IM1 (see FIG. 3A). When the second display area DP_DA2 operates in the second mode, the driver DV (see FIG. 2A) may not perceive the second image IM2 (see FIG. 3A).

In the first mode, when the first switching signal MS1 is activated, the red pixel R_PX, the green pixel G_PX, and the blue pixel B_PX may display an image by using the first red light emitting element R_ED1, the first green light emitting element G_ED1, and the first blue light emitting element B_ED1. In the first mode, the second switching signal MS2 is inactive, and thus the second red light emitting element R_ED2, the second green light emitting element G_ED2, the 2-1st and 2-2nd blue light emitting elements B_ED21 and B_ED22 are turned off.

In the meantime, when the second switching signal MS2 is activated in the second mode, the red pixel R_PX, the green pixel G_PX, and the blue pixel B_PX may display an image by using the second red light emitting element R_ED2, the second green light emitting element G_ED2, the 2-1st and 2-2nd blue light emitting elements B_ED21 and B_ED22. In the second mode, the first switching signal MS1 is inactive, and thus the first red light emitting element R_ED1, the first green light emitting element G_ED1, and the first blue light emitting element B_ED1 are turned off.

Referring to FIGS. 10A and 10B, the first blue light emitting element B_ED1 includes a first blue anode AE1, a first blue light emitting layer EL1, and the cathode CE. The pixel defining film 70 is provided with a first blue opening 70-OP1 that exposes the first blue anode AE1, and the first blue light emitting layer EL1 is disposed on the first blue anode AE1 exposed through the first blue opening 70-OP1.

The 2-1st blue light emitting element B_ED21 includes a second blue anode AE2, a 2-1st blue light emitting layer EL21, and the cathode CE. The 2-2nd blue light emitting element B_ED22 includes the second blue anode AE2, a 2-2nd blue light emitting layer EL22, and the cathode CE. The pixel defining film 70 is provided with 2-1st and 2-2nd blue openings 70-OP21 and 70-OP22 that expose the second blue anode AE2. The 2-1st blue light emitting layer EL21 is disposed on the second blue anode AE2 exposed through the 2-1st blue opening 70-OP21, and the 2-2nd blue light emitting layer EL22 is disposed on the second blue anode AE2 exposed through the 2-2nd blue opening 70-OP22.

The cathode CE is disposed on the first blue light emitting layer EL1, the 2-1st blue light emitting layer EL21, and the 2-2nd blue light emitting layer EL22. The cathode CE is covered by the encapsulation layer TFE.

The base insulating layer 201, the intermediate insulating layer 203, and the cover insulating layer 205 may be sequentially stacked on the encapsulation layer TFE. The second conductive layer 204 may be placed in the non-emission area NPXA. The first conductive layer 202 (see FIGS. 5A and 5B) may be further disposed in the non-emission area NPXA.

The optical path control layer OSL_1 may be disposed on the cover insulating layer 205. The optical path control layer OSL_1 may include a plurality of light absorption walls LAW placed to correspond to the emission area PXA of the narrow light emitting element. Because the first blue light emitting element B_ED1 belongs to the wide light emitting element, the plurality of light absorption walls LAW are not disposed on the first blue light emitting element B_ED1. In the meantime, the 2-1st blue light emitting element B_ED21 and the 2-2nd blue light emitting element B_ED22 belong to the narrow light emitting element, and thus the plurality of light absorption walls LAW are disposed on the 2-1st blue light emitting element B_ED21 and the 2-2nd blue light emitting element B_ED22.

According to an embodiment of the present disclosure, each of the plurality of light absorption walls LAW may include a plurality of black matrices. FIGS. 10A and 10B illustrate a structure in which each of the plurality of light absorption walls LAW is composed of three black matrices (hereinafter, referred to as first to third black matrices BM1, BM2, and BM3), but the structure of each of the plurality of light absorption walls LAW is not limited thereto. For example, each of the plurality of light absorption walls LAW may be composed of one black matrix, or may be composed of two black matrices or four or more black matrices.

The first black matrix BM1 may be disposed on the cover insulating layer 205 and may be covered by a first transparent insulating layer 301. The second black matrix BM2 may be disposed on the first transparent insulating layer 301 and may be covered by a second transparent insulating layer 302. The third black matrix BM3 may be disposed on the second transparent insulating layer 302 and may be covered by a third transparent insulating layer 303. Each of the first to third black matrices BM1, BM2, and BM3 may include a light absorbing material or a light blocking material. Accordingly, light incident on the first to third black matrices BM1, BM2, and BM3 may not be reflected but may be absorbed. Each of the first to third transparent insulating layers 301, 302, and 303 may include a transparent organic material.

The light emission range of the light output from the 2-1st blue light emitting element B_ED21 and the 2-2nd blue light emitting element B_ED22 may be controlled by the plurality of light absorption walls LAW. In other words, the lateral light among light output from the 2-1st and 2-2nd blue light emitting elements B_ED21 and B_ED22 is absorbed by the light absorption wall LAW and is not output to the outside. The light emission range of the light output from the 2-1st blue light emitting element B_ED21 and the 2-2nd blue light emitting element B_ED22 may be narrowed by the light absorption wall LAW, and thus the viewing angle of an image displayed in the display area DA (see FIG. 2A) in the second mode may be narrowed.

The optical path control layer OSL_1 may further include a peripheral wall P_LAW placed to correspond to the non-emission area NPXA. The peripheral wall P_LAW may have a structure including a plurality of peripheral black matrices P_BM1, P_BM2, and P_BM3. Alternatively, the peripheral wall P_LAW in the optical path control layer OSL_1 may be omitted.

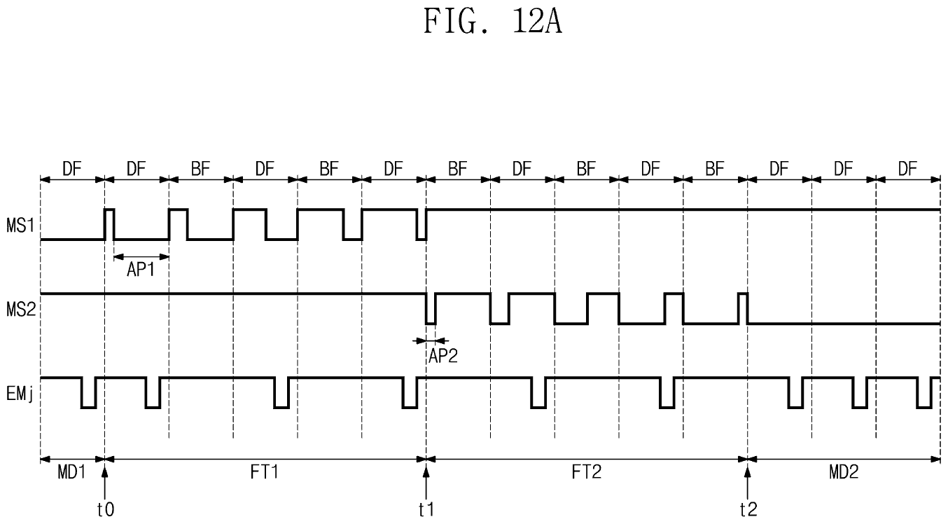

FIGS. 11A and 11B are waveform diagrams showing states of first and second switching signals in a transition period, according to an embodiment of the present disclosure.

Referring to FIGS. 11A and 11B, in a first mode, the first switching signal MS1 has an active state (e.g., a low level), and the second switching signal MS2 has an inactive state (e.g., a high level). In the second mode, the first switching signal MS1 has an inactive state (e.g., a high level), and the second switching signal MS2 has an active state (e.g., a low level). Because the eighth and ninth transistors T8 and T9 shown in FIG. 7 are P-type transistors, active states of the first and second switching signals MS1 and MS2 are defined as low levels. However, when the eighth and ninth transistors T8 and T9 are N-type transistors, the active states of the first and second switching signals MS1 and MS2 may be defined as high levels.

Referring to FIGS. 7 and 11A, a time point, at which a switching request from the first mode to the second mode occurs, may be referred to as a first time point to (also referred to as a “start time point”). A time point, at which the switching from the first mode to the second mode occurs may be referred to as a “mode switching time point t1”. A transition period FFT may be formed during a predetermined period based on the mode switching time point t1. A second time point t2 (also referred to as an “end time point”) may be an end time point of a transition period FFT.

According to an embodiment of the present disclosure, the transition period FFT may include a first transition period FT1 and a second transition period FT2. The first transition period FT1 is a period from the first time point t0 to the mode switching time point t1. The second transition period FT2 is a period from the mode switching time point t1 to the second time point t2. The period before the transition period FFT may be referred to as a first mode normal period MD1. The period after the transition period FFT may be referred to as a second mode normal period MD2. According to an embodiment of the present disclosure, the duration of the first transition period FT1 may be the same as the duration of the second transition period FT2. However, the present disclosure is not limited thereto. For example, the duration of the first transition period FT1 may be greater than the duration of the second transition period FT2.

The first transition period FT1 occurs (or is located) before the mode switching time point t1. During the first transition period FT1, the first switching signal MS1 may alternately have the active state and the inactive state in one frame as a period. As time goes from the first time point t0 to the mode switching time point t1, the duration of a first active period AP1 of the first switching signal MS1 may gradually decrease. During the first transition period FT1, the second switching signal MS2 may remain in an inactive state. As the duration of the first active period AP1 decreases, the turn-on time of a wide light emitting element may decrease. For example, when the target luminance of the first pixel PX1_ij is 400 nit constantly in the first and second modes, the first pixel PX1_ij may have the target luminance during the first mode normal period MD1, and the luminance of the first pixel PX1_ij may have luminance lower than the target luminance during the first transition period FT1. Moreover, the luminance of the first pixel PX1_ij may gradually decrease during the first transition period FT1.

The mode switching time point t1 may be a time point at which a wide light emitting element (e.g., the first light emitting element ED1) in the first pixel PX1_ij is turned off and a narrow light emitting element (e.g., the second light emitting element ED2) is turned on. The second transition period FT2 is initiated after the mode switching time point t1, and the second transition period FT2 follows the first transition period FT1.

During the second transition period FT2, the second switching signal MS2 may alternately have the active state and the inactive state in one frame as a period. As time goes from the mode switching time point t1 to the second time point t2, the duration of a second active period AP2 of the second switching signal MS2 may gradually increase. During the second transition period FT2, the first switching signal MS1 may remain in the inactive state. As the duration of the second active period AP2 increases, the turn-on time of a narrow light emitting element may increase. For example, during the second transition period FT2, the luminance of the first pixel PX1_ij may gradually increase. During the second mode normal period MD2, the first pixel PX1_ij may have the target luminance.

In other words, when the mode switching occurs in a state where the first pixel PX1_ij has the target luminance, a flickering phenomenon may occur during mode switching. However, when the mode transition occurs in a state where the transition period FFT is disposed between the first time point t0 and the second time point t2, and the first pixel PX1_ij has lower luminance than the target luminance, the flickering phenomenon may not be perceived.

Referring to FIGS. 7 and 11B, a time point, at which a switching request from the first mode to the second mode occurs, may be referred to as a first time point to (or a start time point). A time point, at which the switching from the first mode to the second mode occurs may be referred to as a “mode switching time point t1”. According to an embodiment of the present disclosure, the transition period FFT may be formed between the first time point to and the mode switching time point t1. That is, the mode switching time point t1 may be the end time point of the transition period FFT.

During the transition period FFT, the first switching signal MS1 may alternately have the active state and the inactive state in one frame as a period. As time goes from the first time point t0 to the mode switching time point t1, the duration of the first active period AP1 of the first switching signal MS1 may gradually decrease.

During the transition period FFT, the second switching signal MS2 may alternately have the active state and the inactive state in one frame as a period. As time goes from the first time point t0 to the mode switching time point t1, the duration of the second active period AP2 of the second switching signal MS2 may gradually increase. The second active period AP2 of the second switching signal MS2 may not overlap the first active period AP1 of the first switching signal MS1. Accordingly, the first and second light emitting elements ED1 and ED2 within a pixel may not be turned on at the same time.

During the transition period FFT, the wide light emitting element (e.g., the first light emitting element ED1) and the narrow light emitting element (e.g., the second light emitting element ED2) of the first pixel PX1 may be turned on alternately, the turn-on time of the wide light emitting element may be gradually reduced, and the turn-on time of the narrow light emitting element may be gradually increased. When the transition period FFT is disposed between the first mode normal period MD1 and the second mode normal period MD2, the flickering phenomenon may not be perceived during mode switching.

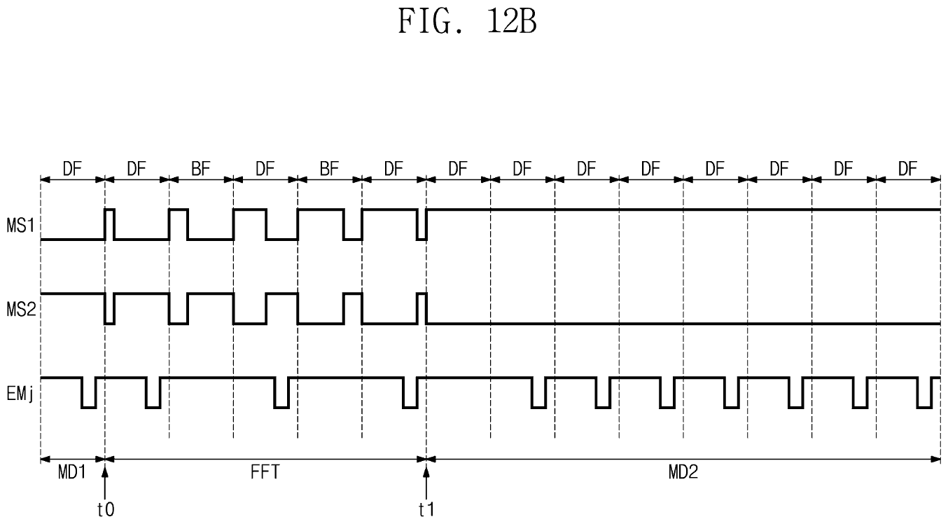

FIGS. 12A and 12B are waveform diagrams showing states of first and second switching signals and an emission control signal in a transition period, according to embodiments of the present disclosure. However, the same reference numerals are given to the same components as those shown in FIGS. 11A and 11B among the components shown in FIGS. 12A and 12B, and thus a detailed description thereof will be omitted.

Referring to FIGS. 7 and 12A, the transition period FFT may be formed between the first time point t0 and the second time point t2. The transition period FFT may include the first transition period FT1 and the second transition period FT2.

During the first transition period FT1, the first switching signal MS1 may alternately have the active state and the inactive state in one frame as a period. As time goes from the first time point t0 to the mode switching time point t1, the duration of the first active period AP1 of the first switching signal MS1 may gradually decrease. During the first transition period FT1, the second switching signal MS2 may remain in an inactive state.

During the second transition period FT2, the second switching signal MS2 may alternately have the active state and the inactive state in one frame as a period. As time goes from the mode switching time point t1 to the second time point t2, the duration of the second active period AP2 of the second switching signal MS2 may gradually increase. During the second transition period FT2, the first switching signal MS1 may remain in the inactive state.

During the first and second mode normal periods MD1 and MD2, the emission control signal EMj may be generated in units of frame. On the other hand, during the transition period FFT, the emission control signal EMj may be generated in units of two frames. FIG. 12A illustrates an embodiment in which the emission control signal EMj is generated in units of two frames during the transition period FFT, but the present disclosure is not limited thereto. For example, the emission control signal EMj may be generated in units of three frames or four frames during the transition period FFT.

In the transition period FFT, a frame in which the emission control signal EMj is generated may be referred to as a “driving frame DF”, and a frame in which the emission control signal EMj is not generated may be referred to as a “black frame BF”. During the black frame BF, the emission control signal EMj may remain in an inactive state (e.g., a high level).

When the emission control signal EMj is deactivated during the black frame BF, the first and second light emitting elements ED1 and ED2 may maintain the turn-off state. Accordingly, when the black frame BF is inserted during the transition period FFT, the flickering phenomenon may be prevented more effectively from occurring during mode switching.

Referring to FIGS. 7 and 12B, the transition period FFT may be formed between the first time point t0 and the mode switching time point t1.

During the transition period FFT, the first switching signal MS1 may alternately have the active state and the inactive state in one frame as a period. As time goes from a first time point t0 to the mode switching time point t1, the duration of the first active period AP1 of the first switching signal MS1 may gradually decrease.

During the transition period FFT, the second switching signal MS2 may alternately have the active state and the inactive state in one frame as a period. As time goes from the first time point t0 to the mode switching time point t1, the duration of the second active period AP2 of the second switching signal MS2 may gradually increase.

During the transition period FFT, the emission control signal EMj may be generated in units of two frames. During the black frame BF, in which the emission control signal EMj is not generated, the emission control signal EMj may remain in an inactive state (e.g., a high level).

When the emission control signal EMj is deactivated during the black frame BF, the first and second light emitting elements ED1 and ED2 may maintain the turn-off state. Accordingly, when the black frame BF is inserted during the transition period FFT, the flickering phenomenon may be prevented more effectively from occurring during mode switching.

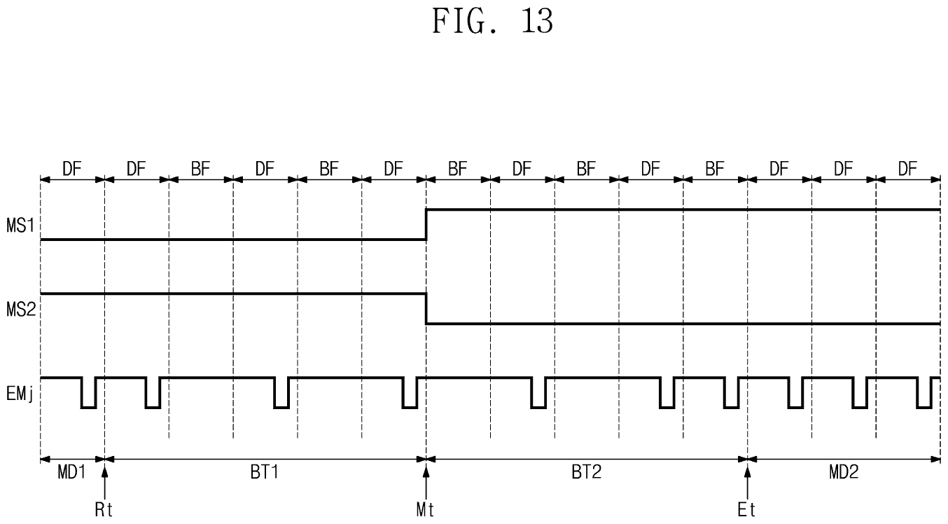

FIG. 13 is a waveform diagram showing states of first and second switching signals and an emission control signal in first and second black frame insertion periods, according to an embodiment of the present disclosure.

Referring to FIGS. 7 and 13, a time point, at which a switching request from the first mode to the second mode occurs, may be referred to as a “request occurrence time point Rt”. A time point, at which the switching from the first mode to the second mode occurs may be referred to as a “mode switching time point Mt”. That is, at the mode switching time point Mt, states of the first and second switching signals MS1 and MS2 may be inverted. Furthermore, a time point at which a black frame is completely inserted may be referred to as an “insertion end time point Et”.

According to an embodiment of the present disclosure, a first black frame insertion period BT1 may be formed between the request occurrence time point Rt and the mode switching time point Mt. A second black frame insertion period BT2 may be formed between the mode switching time point Mt and the insertion end time point Et. The duration of the first black frame insertion period BT1 may be the same as the duration of the second black frame insertion period BT2. However, the present disclosure is not limited thereto. For example, the duration of the first black frame insertion period BT1 may be longer than or shorter than the duration of the second black frame insertion period BT2.

During the first mode normal period MD1 and the first black frame insertion period BT1, the first switching signal MS1 has an active state (e.g., a low level), and the second switching signal MS2 has an inactive state (e.g., a high level). In the meantime, during the second black frame insertion period BT2 and the second mode normal period MD2, the first switching signal MS1 has an inactive state (e.g., a high level), and the second switching signal MS2 has an active state (e.g., a low level).

During the first and second mode normal periods MD1 and MD2, the emission control signal EMj may be generated in units of frame. On the other hand, during the first and second black frame insertion periods BT1 and BT2, the emission control signal EMj may be generated in units of two frames. FIG. 13 illustrates an embodiment in which the emission control signal EMj is generated in units of two frames during the first and second black frame insertion periods BT1 and BT2, but the present disclosure is not limited thereto. For example, the emission control signal EMj may be generated in units of three frames or four frames during the first and second black frame insertion periods BT1 and BT2.

In the first and second black frame insertion periods BT1 and BT2, a frame in which the emission control signal EMj is generated may be referred to as the “driving frame DF”, and a frame in which the emission control signal EMj is not generated may be referred to as the “black frame BF”. During the black frame BF, the emission control signal EMj may remain in an inactive state (e.g., a high level).

When the emission control signal EMj is deactivated during the black frame BF, the first and second light emitting elements ED1 and ED2 may maintain the turn-off state. Accordingly, when the black frame BF is inserted during the first and second black frame insertion periods BT1 and BT2, the flickering phenomenon may be prevented from occurring during mode switching.

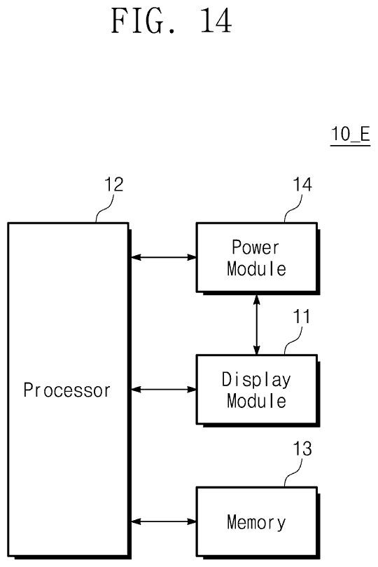

FIG. 14 is a block diagram of the electronic device according to an embodiment of the present disclosure.

Referring to FIG. 14, the electronic device 10_E according to an embodiment may include a display module 11, a processor 12, a memory 13, and a power module 14.

The processor 12 may control operation of the display module 11 and may include at least one selected from a central processing unit (CPU), an application processor (AP), a graphic processing unit (GPU), a communication processor (CP), an image signal processor (ISP), and a controller.

Data information required or utilized for operation of the processor 12 or the display module 11 may be stored in the memory 13. When the processor 12 executes an application stored in the memory 13, an image data signal and/or an input control signal may be transferred to the display module 11, and the display module 11 may process the provided signal and may output image information through a display screen.

The power module 14 may include a power supply module, such as a power adaptor and/or a battery device, and a power conversion module that converts power supplied by the power supply module and generates power required or utilized for operation of the electronic device 10_E.

At least one of the components of the electronic device 10_E described above may be included in the display module 11 according to the embodiments described above. In embodiments, some of the separate modules functionally included in one module may be included in the display module 11, and the other separate modules may be provided separately from the display module 11. For example, the display module 11 may be included in the display device, and the processor 12, the memory 13, and the power module 14 may be provided in the form of other devices within the electronic device 10 rather than the display device.

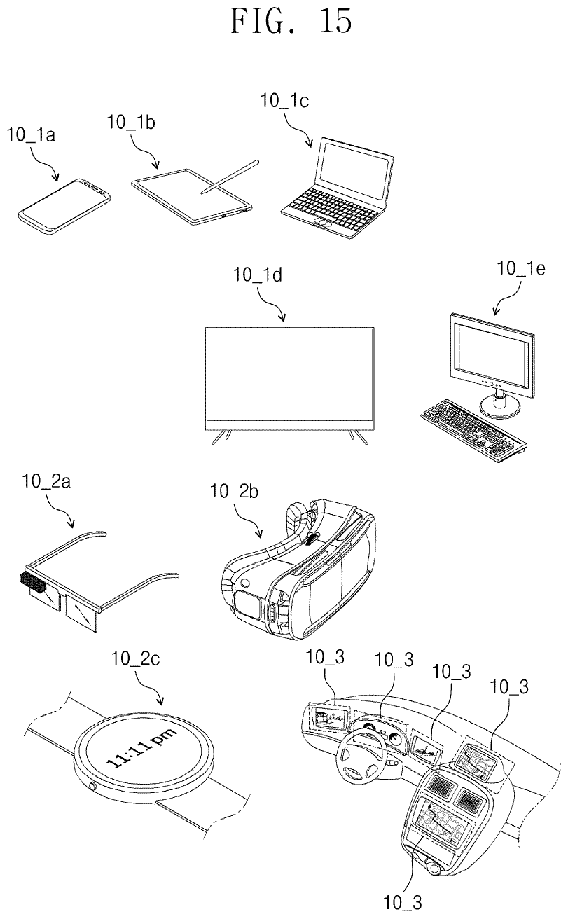

FIG. 15 illustrates schematic views of electronic devices according to various embodiments.

Referring to FIG. 15, the electronic devices according to the various embodiments, to which the display module is applied, may include not only an electronic device to display an image, such as a smart phone 10_1a, a tablet PC 10_1b, a laptop computer 10_1c, a TV 10_1d, or a desk monitor 10_1e, but also a wearable electronic device, such as smart glasses 10_2a, a head mounted display 10_2b, and/or a smart watch 10_2c, and a vehicle electronic device 10_3, such as a center information display (CID) and/or a room mirror display provided on an instrument panel, a center fascia, and/or a dashboard of a vehicle.

Although an embodiment of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

As described above, in a display panel operating in a first mode or a second mode, an active period of first and second switching signals applied to pixels during a predetermined period may be gradually increased or decreased based on a mode switching time point from the first mode to the second mode. Accordingly, the flickering phenomenon may be prevented during a mode switch, and thus the display quality may be improved.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device, comprising:
a display panel including a pixel; and
a driving circuit configured to drive the display panel,
wherein the pixel includes:
a first light emitting element;
a second light emitting element; and
a pixel circuit unit configured to drive the first light emitting element and the second light emitting element,
wherein the pixel circuit unit includes:
a first switching circuit electrically connected to the first light emitting element and configured to apply a driving current to the first light emitting element in response to a first switching signal activated in a first mode; and
a second switching circuit electrically connected to the second light emitting element and configured to apply the driving current to the second light emitting element in response to a second switching signal activated in a second mode,
wherein a duration of an active period of at least one of the first switching signal and the second switching signal gradually increases or decreases during a predetermined period based on a mode switching time point.

2. The electronic device of claim 1, wherein during a first transition period located before the mode switching time point, the duration of the active period of the first switching signal gradually decreases, and
wherein during a second transition period initiated after the mode switching time point, the duration of the active period of the second switching signal gradually increases.

3. The electronic device of claim 2, wherein during the first transition period, the second switching signal maintains an inactive state, and
wherein during the second transition period, the first switching signal maintains an inactive state.

4. The electronic device of claim 2, wherein a duration of the first transition period is the same as a duration of the second transition period.

5. The electronic device of claim 2, wherein during the first transition period, the first switching signal alternately has an active state and an inactive state in one frame as a period, and
wherein during the second transition period, the second switching signal alternately has an active state and an inactive state in one frame as a period.

6. The electronic device of claim 4, wherein the pixel circuit unit receives an emission control signal, and
wherein at least one of the first transition period and the second transition period includes a black frame in which the emission control signal is deactivated.

7. The electronic device of claim 1, wherein during a transition period located before the mode switching time point, the duration of the active period of the first switching signal gradually decreases, and
wherein during the transition period, the duration of the active period of the second switching signal gradually increases.

8. The electronic device of claim 7, wherein the active period of the first switching signal does not overlap the active period of the second switching signal.

9. The electronic device of claim 7, wherein during the transition period, the duration of the active period of the first switching signal increases in units of one frame, and
wherein during the transition period, the duration of the active period of the second switching signal decreases in units of the one frame.

10. The electronic device of claim 9, wherein the pixel circuit unit receives an emission control signal, and
wherein the transition period includes a black frame in which the emission control signal is deactivated.

11. The electronic device of claim 1, wherein the first switching circuit includes a first mode switching transistor connected between a common node and an anode of the first light emitting element and configured to receive the first switching signal, and
wherein the second switching circuit includes a second mode switching transistor connected between the common node and an anode of the second light emitting element and configured to receive the second switching signal.

12. The electronic device of claim 11, wherein the pixel circuit unit further includes:
a first transistor connected between a first driving voltage line and the common node, and controlled depending on a potential of a first node;
a second transistor connected between a data line and the first node; and
an emission control transistor connected between the common node and the first transistor and configured to operate in response to an emission control signal.

13. The electronic device of claim 12, wherein the pixel circuit unit further includes:
a first initialization transistor connected between the anode of the first light emitting element and an initialization voltage line; and
a second initialization transistor connected between the anode of the second light emitting element and the initialization voltage line.

14. The electronic device of claim 1, wherein the first mode is a wide viewing angle mode,
wherein the second mode is a narrow viewing angle mode, and
wherein the display panel further includes:
a light absorption wall disposed on the second light emitting element and configured to narrow a light emission range of light output from the second light emitting element in the second mode.

15. The electronic device of claim 1, wherein the display panel further includes:
a first display area; and
a second display area adjacent to the first display area, and
wherein a mode of at least one of the first display area and the second display area is switched to the first mode or the second mode.

16. An electronic device, comprising:
a display panel including a pixel; and
a driving circuit configured to drive the display panel,
wherein the pixel includes:
a first light emitting element;
a second light emitting element; and
a pixel circuit unit configured to drive the first light emitting element and the second light emitting element,
wherein the pixel circuit unit includes:
a first switching circuit electrically connected to the first light emitting element and configured to apply a driving current to the first light emitting element in response to a first switching signal activated in a first mode; and
a second switching circuit electrically connected to the second light emitting element and configured to apply the driving current to the second light emitting element in response to a second switching signal activated in a second mode,
wherein the pixel circuit unit receives an emission control signal, and
wherein a predetermined period set based on a mode switching time point includes a black frame in which the emission control signal is deactivated.

17. The electronic device of claim 16, wherein the predetermined period includes a first black frame insertion period that occurs before the mode switching time point, and a second black frame insertion period that occurs after the mode switching time point.

18. The electronic device of claim 17, wherein during the first black frame insertion period, the first switching signal maintains an active state, and the second switching signal maintains an inactive state, and
wherein during the second black frame insertion period, the first switching signal maintains an inactive state, and the second switching signal maintains an active state.

19. The electronic device of claim 16, wherein the first switching circuit includes a first mode switching transistor connected between a common node and an anode of the first light emitting element and configured to receive the first switching signal, and
wherein the second switching circuit includes a second mode switching transistor connected between the common node and an anode of the second light emitting element and configured to receive the second switching signal.

20. The electronic device of claim 19, wherein the pixel circuit unit further includes:
a first transistor connected between a first driving voltage line and the common node, and controlled depending on a potential of a first node;
a second transistor connected between a data line and the first node;
an emission control transistor connected between the common node and the first transistor and configured to operate in response to the emission control signal;
a first initialization transistor connected between the anode of the first light emitting element and an initialization voltage line; and
a second initialization transistor connected between the anode of the second light emitting element and the initialization voltage line.
